(19) United States
(12) Patent Application Publication
(10) Pub. No.: US 2022/0254038 A1
(43) Pub. Date: Aug. 11, 2022

(54) IMAGE PROCESSING DEVICE AND IMAGE PROCESSING METHOD

(71) Applicant: PANASONIC INTELLECTUAL PROPERTY MANAGEMENT CO., LTD., Osaka (JP)

(72) Inventor: Ryuji FUCHIKAMI, Fukuoka (JP)

(73) Assignee: PANASONIC INTELLECTUAL PROPERTY MANAGEMENT CO., LTD., Osaka (JP)

(21) Appl. No.: 17/624,718

(22) PCT Filed: Jul. 3, 2020
(86) PCT No.: PCT/JP2020/026301

§ 371 Date: Jan. 4, 2022

(30) Foreign Application Priority Data
Jul. 9, 2019 (JP) 2019-127912

(51) Int. Cl. G06T 7/292; G06T 7/73; G06T 7/246; H04N 5/268

(52) U.S. Cl. CPC G06T 7/292; G06T 7/73; G06T 2207/30241; H04N 5/268; G06T 7/246

(57) ABSTRACT

An image processing device includes: a reception unit that receives position information of a capturing target and a captured image of the capturing target captured by at least one camera, a prediction unit that predicts a position of the capturing target within a capturing range of the camera based on the position information of the capturing target; a detection unit that detects the capturing target by reading a captured image of a limitation range that is a part of the capturing range from the captured image of the capturing range based on a predicted position of the capturing target; a measurement unit that measures a position of a detected capturing target; and an output unit that outputs a difference between a measured position of the capturing target and the predicted position.

### TECHNICAL FIELD

The present disclosure relates to an image processing device and an image processing method.

### BACKGROUND ART

Patent Literature 1 discloses a component mounting coordinate correction method in which, when an electronic component is mounted on a printed circuit board, an operator measures coordinates of a mark serving as a reference at the time of positioning and inputs the coordinates to the printed circuit board, in which coordinates of two points of an electronic component mounting position pattern close to a pattern position of the mark are obtained, a true mark position is determined based on a deviation amount between a true coordinate position of a mounting position pattern and a coordinate position including an error based on the coordinates of the mark via a capturing unit, and a component mounting coordinate is corrected based on the true mark position.

### CITATION LIST

### Patent Literature

Patent Literature 1: JP-A-2001-284899

### SUMMARY OF INVENTION

### Technical Problem

However, in the configuration of Patent Literature 1, since an error caused by an external cause such as a movement error when the coordinates are moved from the mark position to the component mounting coordinates after the correction cannot be corrected, there is a limit in accuracy in the correction of position information. In addition, in the configuration of Patent Literature 1, for example, image processing of a captured image captured by a camera is executed in order to calculate a deviation amount between design coordinates and actual coordinates and correct a coordinate error. However, the method of correcting the coordinate error using the captured image requires a predetermined time until the coordinate error is calculated due to a capturing speed, reading of the captured image, the read image processing, and the like, and may be a constraint factor on improvement of an operation speed (for example, a mounting speed of the electronic component) of another device.

The present disclosure has been devised in view of the above-described circumstances in the related art. An object of the present disclosure is to provide an image processing device and an image processing method that execute efficient image processing on an image of an object captured by a camera and calculate a position error of the object with higher accuracy.

### Solution to Problem

According to an aspect of the present disclosure, an image processing device includes: a reception unit that receives position information of a capturing target and a captured image of the capturing target captured by at least one camera, a prediction unit that predicts a position of the capturing target within a capturing range of the camera based on the position information of the capturing target; a detection unit that detects the capturing target by reading a captured image of a limitation range that is a part of the capturing range from the captured image of the capturing range based on a predicted position of the capturing target; a measurement unit that measures a position of a detected capturing target; and an output unit that outputs a difference between a measured position of the capturing target and the predicted position.

According to another aspect of the present disclosure, an image processing device includes: a reception unit that receives position information of at least one camera and a captured image captured by the at least one camera; a detection unit that reads a captured image in a limitation range, which is a part of a capturing range of the camera, from at least captured image and detect a capturing target serving as a reference of a position of the camera; a measurement unit that measures a position of a detected capturing target; and a prediction unit that predicts, based on a measured position of the capturing target, a position of the capturing target appearing in a captured image captured after the captured image used for detection of the capturing target was captured; and an output unit that outputs a difference between a predicted position of the capturing target and the measured position of the capturing target.

Further, the present disclosure provides an image processing method to be executed by an image processing device connected to at least one camera, the image processing method including: receiving position information of a capturing target and a captured image including the capturing target captured by the camera; predicting a position of the capturing target within a capturing range of the camera based on the position information of the capturing target; detecting the capturing target by reading a predetermined limitation range including the predicted position in the capturing range of the camera based on a predicted position of the capturing target; measuring a position of the detected capturing target; and outputting a difference between a measured position of the capturing target and the predicted position.

Further, the present disclosure provides an image processing method to be executed by an image processing device connected to at least one camera, the image processing method including: receiving a captured image including a capturing target captured by the camera; reading a captured image in a limitation range, which is a part of a capturing range of the camera, from at least one captured image and detecting a capturing target serving as a reference of a position of the camera; measuring a position of a detected capturing target; predicting, based on a measured position of the capturing target, a position of the capturing target appearing in a captured image captured after the captured image used for detection of the capturing target was captured; and outputting a difference between a predicted position of the capturing target and the measured position of the capturing target.

### Advantageous Effects of Invention

According to the present disclosure, it is possible to execute efficient image processing on an image of an object captured by a camera and to calculate a position error of the object with higher accuracy.

### BRIEF DESCRIPTION OF DRAWINGS

FIG. 1 is an explanatory diagram of an example of a use case of an image processing system according to a first embodiment.

FIG. 2 is a time chart showing an example of image reading and image processing according to a comparative example.

FIG. 3 is a time chart showing an example of image reading and image processing in an image processing device according to the first embodiment.

FIG. 4 is a diagram showing an example of each of a capturing range and a limitation range.

FIG. 5 is a diagram showing a state of an example of a temporal change in a capturing target appearing in each of a plurality of limitation ranges.

FIG. 6 is a sequence diagram showing an example of an operation procedure of the image processing system according to the first embodiment.

FIG. 7 is a flowchart showing an example of a basic operation procedure of the image processing device according to the first embodiment.

FIG. 8 is an explanatory diagram of an example of a use case of the image processing system including each of a plurality of cameras according to a second embodiment.

FIG. 9 is a flowchart showing an example of an operation procedure of the image processing device including each of the plurality of cameras according to the second embodiment.

FIG. 10 is a diagram showing an example of detection of feature points.

FIG. 11 is a flowchart showing an example of an operation procedure of the image processing device that detects the feature point according to the second embodiment.

FIG. 12 is an explanatory diagram of an example of a use case of the image processing system including a drone according to the second embodiment.

FIG. 13 is a flowchart showing an example of a tracking and detection operation procedure of the image processing device according to the second embodiment.

FIG. 14 is a diagram showing an example of switching limitation ranges between a tracking limitation range and a detection limitation range.

FIG. 15 is a diagram showing an example of the tracking and the detection of a capturing target.

### DESCRIPTION OF EMBODIMENTS

(Introduction to Contents of First Embodiment)

For example, there is a component mounting coordinate correction method for correcting a component mounting coordinate when an electronic component is mounted on a printed circuit board. In such a component mounting coordinate correction method, an operator measures coordinates of a mark serving as a reference at the time of positioning and inputs the coordinates to the printed circuit board, determines a true mark position based on a deviation amount from a coordinate position including an error via a capturing unit, and corrects the component mounting coordinates based on the true mark position. However, since an error caused by an external cause such as a movement error when the coordinates are moved from the mark position to the component mounting coordinates after the correction cannot be corrected, there is a limit in accuracy in the correction of position information. In addition, since the component mounting coordinate correction via the capturing unit requires a predetermined time until the coordinate error is calculated due to the capturing speed, the reading of the captured image, the read image processing, and the like, there is a limit to improvement of the operation speed of another device, for example, the mounting speed of the electronic component. That is, in the component mounting coordinate correction method using such a captured image, there is a limit to the number of captured images to be subjected to image processing in consideration of influence on the operation speed of other devices, and it is difficult to increase the number of samplings for implementing error correction with higher accuracy. In Patent Literature 1 described above, in the coordinate correction method using the capturing unit, it is not assumed that the time required for the image processing is shortened.

As described above, an example of an image processing device and an image processing method will be described in which the image processing device executes efficient image processing on an image of an object captured by a camera and calculates a position error of the object with higher accuracy.

Hereinafter, a first embodiment specifically disclosing configurations and operations of an image processing device and an image processing method according to the present disclosure will be described in detail with reference to the drawings as appropriate. However, an unnecessarily detailed description may be omitted. For example, a detailed description of a well-known matter or a repeated description of substantially the same configuration may be omitted. This is to avoid unnecessary redundancy in the following description and to facilitate understanding of those skilled in the art. Note that the accompanying drawings and the following description are provided for a thorough understanding of the present disclosure by those skilled in the art, and are not intended to limit the subject matter recited in the claims.

### First Embodiment

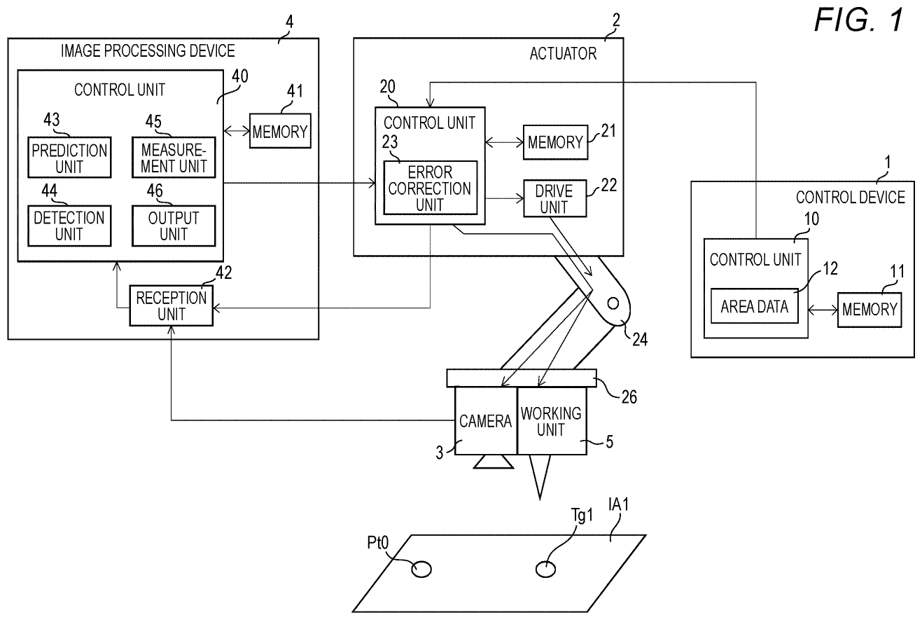

FIG. 1 is an explanatory diagram of an example of a use case of an image processing system according to a first embodiment. The image processing system includes a control device 1, an actuator 2, a camera 3, and an image processing device 4. The control device 1 is a device for controlling the actuator 2, the camera 3, and the image processing device 4.

First, the control device 1 will be described. The control device 1 includes a control unit 10, a memory 11, and area data 12. The control device 1 is communicably connected to the actuator 2.

The control unit 10 is configured using, for example, a central processing unit (CPU) or a field programmable gate array (FPGA), and performs various processing and control in cooperation with the memory 11. Specifically, the control unit 10 implements a function of the area data 12 described later by referring to a program and data held in the memory 11 and executing the program. The control unit 10 is communicably connected to a control unit 20 of the actuator 2. The control unit 10 controls the actuator 2 based on the area data 12 input by a user operation.

The memory 11 includes, for example, a random access memory (RAM) serving as a work memory used when various types of processing of the control unit 10 is executed, and a read only memory (ROM) that stores data and a program specifying an operation of the control unit 10. Data or information generated or acquired by the control unit 10 is temporarily stored in the RAM. A program that defines the operation of the control unit 10 (for example, a method of reading data and a program written in the area data 12 and controlling the actuator 2 based on the data and the program) is written in the ROM.

The area data 12 is, for example, data created using a design support tool such as a computer aided design (CAD). The area data 12 is data having design information or position information (for example, position information related to a capturing target Tg1 which is stored in the area data 12 and is captured by the camera 3, and position information for a working unit 5 to execute mounting, soldering, welding, or the like of a component), and a program or the like for moving a driving device such as the actuator 2 is written in the area data 12.

Next, the actuator 2 will be described. The actuator 2 is, for example, a driving device capable of electric control or flight control. The actuator 2 is communicably connected to the control device 1 and the image processing device 4. The actuator 2 includes the control unit 20, a memory 21, a drive unit 22, and an arm unit 24. The working unit 5 is not an essential component, and may be omitted.

The control unit 20 is configured using, for example, a CPU or an FPGA, and performs various processing and control in cooperation with the memory 21. Specifically, the control unit 20 implements a function of an error correction unit 23 by referring to a program and data held in the memory 21 and executing the program. The control unit 20 is communicably connected to the control unit 10, a control unit 40, and a reception unit 42. The control unit 20 drives the drive unit 22 based on a control signal received from the control device 1, and causes the working unit 5 to execute predetermined control.

When the actuator 2 is activated, the control unit 20 executes initial alignment based on a reference marker Pt0 of the camera 3 and the working unit 5 driven by the drive unit 22. The initial alignment may be executed at any timing designated by the user, for example, at the time of changing the capturing target, or the end of work by the working unit 5.

The control unit 20 transmits various kinds of information such as the position information of the capturing target Tg1 included in the area data 12 received from the control device 1 and the position information of the camera 3 to the image processing device 4. The various kinds of information include information such as a frame rate of the camera 3, a capturing range IA1, and a zoom magnification. In addition, when moving a capturing position of the camera 3 based on the program written in the area data 12, the control unit 20 transmits information enabling estimation of the position of the camera 3 (for example, position information of the camera 3, or moving speed information of the camera 3) to the image processing device 4. The information enabling estimation of the position of the camera 3 may be omitted, for example, when the camera 3 is fixed or when all positions where the capturing target Tg1 can be positioned are included in the capturing range IA1 of the camera 3.

The control unit 20 receives, from the image processing device 4, difference information (in other words, position error information) related to the position of the capturing target Tg1 based on the captured image captured by the camera 3. The control unit 20 causes the error correction unit 23 to execute error correction based on the received difference information.

The memory 21 includes, for example, a RAM serving as a work memory used when various types of processing of the control unit 20 is executed, and a ROM that stores data and a program specifying an operation of the control unit 20. Data or information generated or acquired by the control unit 20 is temporarily stored in the RAM. In the ROM, a program that defines an operation of the control unit 20 (for example, a method of moving the camera 3 and the working unit 5 to a predetermined position based on the control signal of the control device 1) is written.

The drive unit 22 moves the camera 3 and the working unit 5 based on the position information of the capturing target Tg1 with the reference marker Pt0 as a base point. The drive unit 22 transmits the moving speeds of the camera 3 and the working unit 5 to the image processing device 4 via the control unit 20.

The error correction unit 23 corrects the positions of the camera 3 and the working unit 5 moved by the drive unit 22 based on the difference information received from the image processing device 4. When the camera 3 and the working unit 5 are fixedly installed, the error correction unit 23 corrects the position information of the capturing target Tg1 stored in the area data 12 (that is, CAD data or the like) based on the received difference information.

The arm unit 24 is connected to a support table 26 on which the camera 3 and the working unit 5 are integrally supported. The arm unit 24 is driven by the drive unit 22, and integrally moves the camera 3 and the working unit 5 via the support table 26.

The camera 3 includes a charge coupled device (CCD) or a complementary metal oxide semiconductor (CMOS) as a capturing element. The camera 3 includes a focus lens (not shown) capable of adjusting a focal length, a zoom lens (not shown) capable of changing a zoom magnification, and a gain adjustment unit (not shown) capable of adjusting sensitivity of the capturing element.

The camera 3 is configured using, for example, a central processing unit (CPU), a micro processing unit (MPU), a digital processor (DSP), or a field programmable gate array (FPGA). The camera 3 performs predetermined signal processing using an electric signal of the captured image, thereby generating data (frame) of the captured image defined by red green blue (RGB), YUV (luminance and color difference), or the like, which can be recognized by a human being. The camera 3 transmits the captured data of the captured image (hereinafter, the captured image) to the image processing device 4. The captured image captured by the camera 3 is stored in a memory 41.

The camera 3 has the capturing range IA1. The camera 3 is a high-speed camera that generates data (frame) of the captured image of the capturing target Tg1 at a predetermined frame rate (for example, 120 fps (frame per second)). The predetermined frame rate may be optionally set by a user in accordance with a magnitude of the capturing range IA1 and a magnitude of a limitation range described later. Specifically, the predetermined frame rate may be, for example, 60 fps or 240 fps.

Although the camera 3 shown in FIG. 1 is provided such that the capturing position can be changed by the arm unit 24, the camera 3 may be fixed and installed on a bottom surface or a side surface of the actuator 2 in accordance with an application, or may be fixed and installed on another support table (not shown) or the like capable of capturing the capturing target Tg1. Although the capturing range IA1 of the camera 3 shown in FIG. 1 indicates a range including the reference marker Pt0 and the capturing target Tg1, when the capturing position of the camera 3 is variably set, the reference marker Pt0 and the capturing target Tg1 may be captured at different predetermined capturing positions. That is, the camera 3 according to the first embodiment may be installed so as to be able to capture the reference marker Pt0 and the capturing target Tg1, or may have the capturing range IA1 in which the capturing is possible.

Further, when the capturing position of the camera 3 is fixed and the capturing range IA1 of the camera 3 can capture all positions where the capturing target Tg1 can be arranged, the reference marker Pt0 may be omitted. That is, in such a case, the camera 3 according to the first embodiment only needs to be capable of capturing the capturing target Tg1.

Next, the image processing device 4 will be described. The image processing device 4 is communicably connected to the actuator 2 and the camera 3. The image processing device 4 includes the control unit 40, the memory 41, and the reception unit 42.

The control unit 40 is configured using, for example, a CPU or an FPGA, and performs various processing and control in cooperation with the memory 41. Specifically, the control unit 40 refers to a program and data held in the memory 41, and executes the program to implement the functions of the respective units. Each unit includes a prediction unit 43, a detection unit 44, a measurement unit 45, and an output unit 46.

The memory 41 includes, for example, a RAM serving as a work memory used when various types of processing of the control unit 40 is executed, and a ROM that stores data and a program specifying an operation of the control unit 40. Data or information generated or acquired by the control unit 40 is temporarily stored in the RAM. A program that defines the operation of the control unit 40 (for example, a method of predicting the position of the received capturing target Tg1, a method of detecting the capturing target Tg1 from the read limitation range, or a method of measuring the position of the detected capturing target Tg1) is written in the ROM. The memory 41 stores the received captured image, the position information of the capturing target Tg1, the limitation range to be described later, and the like.

The reception unit 42 is communicably connected to the control unit 20 of the actuator 2 and the camera 3. The reception unit 42 receives the position information of the capturing target Tg1 and the information enabling estimation of the position of the camera 3 (for example, the position information of the camera 3 or the moving speed information of the camera 3) from the control unit 20, outputs the received position information of the capturing target Tg1 and the information enabling estimation of the position of the camera 3 to the prediction unit 43, and outputs the received position information of the capturing target Tg1 to the output unit 46. The reception unit 42 receives data of the captured image captured by the camera 3, and outputs the received data of the captured image to the detection unit 44.

The reception unit 42 outputs the received various kinds of information of the camera 3 to the control unit 40. The various kinds of information output by the reception unit 42 are further output to each unit by the control unit 40.

The prediction unit 43 predicts the position of the capturing target Tg1 appearing in the received captured image based on the position information of the capturing target Tg1 stored in the area data 12 and the information enabling estimation of the position of the camera 3 moved by the actuator 2 output from the reception unit 42. Specifically, the prediction unit 43 predicts the position of the capturing target Tg1 in an image sensor of the camera 3. The prediction unit 43 outputs a predicted position of the capturing target Tg1 to the detection unit 44 and the output unit 46. The position of the capturing target Tg1 predicted by the prediction unit 43 may be not only the position of a next frame (specifically, a captured image captured after the captured image used to detect the capturing target) but also a position of the capturing target Tg1 captured after several frames.

The detection unit 44 limitedly reads a limitation range in the image sensor, which includes the predicted position predicted by the prediction unit 43 (that is, the predicted position of the capturing target Tg1 in the image sensor) and is a part of the capturing range IA1, from the captured image captured and received by the camera 3, and detects the capturing target Tg1 appearing in the limitation range of the captured image. The detection unit 44 outputs a detection result to the measurement unit 45. The limitation range may be a predetermined range set in advance in the memory 41 or a predetermined range centered on the predicted position. The limitation range will be described later.

In this manner, the detection unit 44 can shorten a time required for read processing by limitedly reading the limitation range of the capturing range IA1, as compared with read processing targeting an entire area of the captured image in a comparative example. In addition, the detection unit 44 can reduce a load required for the read processing by reducing a read range. Therefore, the image processing device 4 according to the first embodiment can execute efficient image processing on the image of the capturing target Tg1 captured by the camera 3 and calculate the position error of the capturing target Tg1 with higher accuracy.

Further, in the method of correcting the coordinate error using the captured image in the comparative example, since it takes time to perform the read processing, the number of captured images to be subjected to the image processing is limited in consideration of influence on an operation speed of other devices. However, since the image processing device 4 according to the first embodiment can shorten the reading time by limitedly reading the limitation range of the capturing range IA1, it is possible to prevent the influence on the operation speed of other devices. The image processing device 4 according to the first embodiment can increase the number of samplings by shortening the reading time, and thus can implement more accurate position error correction.

The measurement unit 45 measures the position of the capturing target Tg1 appearing in the limitation range on the captured image detected by the detection unit 44. The measurement unit 45 outputs a measured position of the capturing target Tg1 to the output unit 46.

The output unit 46 outputs a difference between the predicted position of the capturing target Tg1 in the image sensor and the measured position in the actually captured image. Accordingly, the output unit 46 can output an error between the position of the capturing target Tg1 received from the actuator 2 and the actually detected position.

The output unit 46 transmits the calculated difference information (in other words, error information) to the error correction unit 23 of the actuator 2. The error correction unit 23 corrects, based on the received difference information, an error related to the position of the arm unit 24 driven by the drive unit 22 (in other words, the capturing position of the camera 3 and a working position of the working unit 5).

The working unit 5 is, for example, a component mounting head on which the electronic component can be mounted, a solderable soldering iron, and a weldable welding rod. The position of the working unit 5 is variably driven by the drive unit 22. The working unit 5 may be provided so as to be able to replace a working unit capable of executing the work requested by the user as described above.

The capturing target Tg1 is set based on the area data 12. In the description of FIG. 1, the capturing target Tg1 remains at a predetermined position, whereas the present invention is not limited thereto. The capturing target Tg1 is, for example, a component, and the position of the capturing target Tg1 may be changed at a constant speed such as a transport rail. In this case, the image processing device 4 receives the moving speed information of the camera 3 and the moving speed information of the capturing target Tg1, and executes the image processing in consideration of a relative speed.

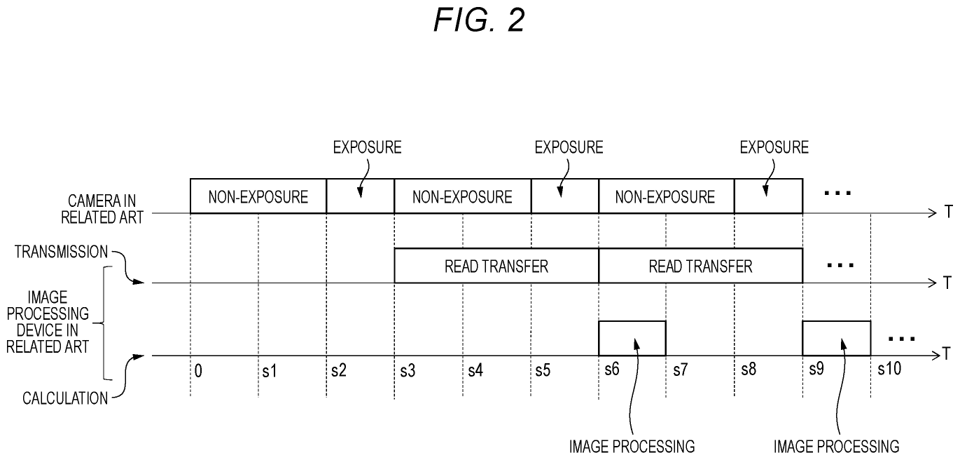

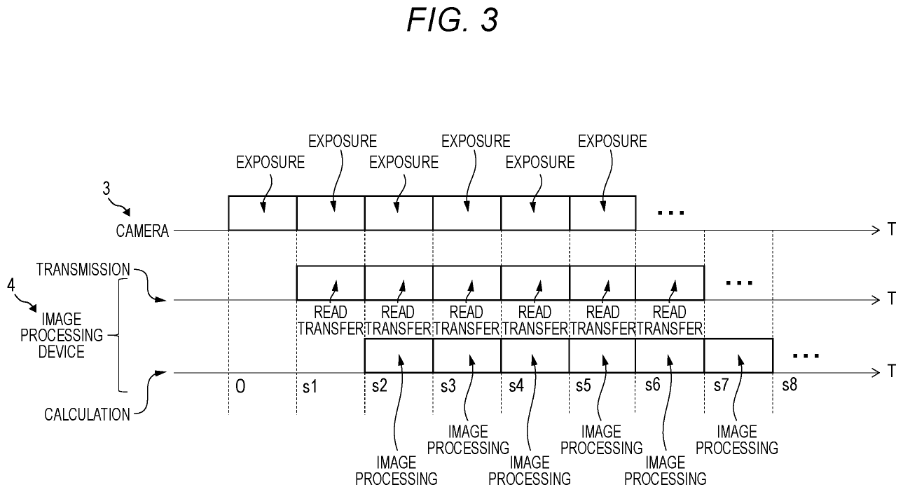

Next, with reference to FIGS. 2 and 3, the time required for the image processing of the camera in the comparative example is compared with the time required for the image processing of the camera 3 according to the first embodiment. FIG. 2 is a time chart showing an example of image reading and image processing according to the comparative example. FIG. 3 is a time chart showing an example of image reading and image processing in the image processing device according to the first embodiment. Among the processing executed by the image processing device 4 shown in FIGS. 2 and 3, transmission indicates processing of reading the captured image. In the calculation, the capturing target Tg1 is detected from the read captured image, the position of the detected capturing target Tg1 is measured, and the difference between the position of the detected capturing target Tg1 and the position of the capturing target Tg1 in design is calculated and output. The capturing range of the camera in the comparative example shown in FIG. 2 and the camera 3 according to the first embodiment shown in FIG. 3 is the capturing range IA1.

The camera in the comparative example shown in FIG. 2 is in a non-exposure state between a time 0 (zero) and a time s2, and is in an exposure state between the time s2 and a time s3. When the exposure state of the camera in the comparative example ends, the image processing device according to the comparative example reads the entire area of the capturing range IA1 from the time s3 to a time s6, and executes the image processing from the time s6 to a time s7. That is, the image processing system using the camera and the image processing device in the comparative example requires the time s7 to output one error.

On the other hand, the camera 3 according to the first embodiment shown in FIG. 3 ends the exposure state between the time 0 (zero) and the time s1. The image processing device 4 starts the read processing from the time s1 at which the camera 3 ends the exposure state. The image processing device 4 limitedly reads only a limited region in the captured capturing range IA1, thereby ending the read processing between the time s1 and the time s2 and completing the image processing between the time s2 and the time s3. That is, the image processing system according to the first embodiment requires the time s3 to output one error. Therefore, in the image processing system according to the first embodiment, since the time required for reading and transferring is shortened, as shown in FIG. 3, the camera 3 can quickly repeat the exposure state and output a larger number of errors quickly.

As described above, the image processing system according to the first embodiment can shorten the time required for the read processing and set the frame rate of the camera 3 faster by limiting the reading of the image in the image processing device 4 to the limitation range. Accordingly, the image processing system according to the first embodiment can obtain a larger number of samplings (in other words, the number of pieces of error information to be output) in the same time, and thus the accuracy of the position error correction can be made higher.

The camera 3 may have a period of time during which the camera 3 is in the non-exposure state without repeating the exposure state one after another as shown in FIG. 3.

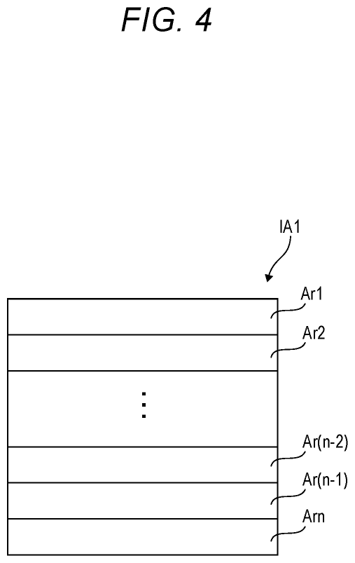

FIG. 4 is a diagram showing an example of the capturing range IA1 and each of the limitation ranges Ar1, Ar2, . . . , Ar(n−2), Ar(n−1), and Arn. Each of the plurality of limitation ranges Ar1, . . . , Arn is a part of the capturing range IA1. Each of the plurality of limitation ranges Ar1, . . . , Arn may be set in advance and stored in the memory 41. Each of the plurality of limitation ranges Ar1 to Arn shown in FIG. 4 shows an example in which the capturing range IA1 is divided into a rectangular shape, but may be, for example, a square shape.

Further, the limitation range may be a predetermined range centered on the predicted position, instead of the range set in advance as shown in FIG. 4. The limitation range may be, for example, a circular shape having a predetermined radius centered on the predicted position of the capturing target Tg1 predicted by the prediction unit 43, or a quadrangular shape in which the predicted position of the capturing target Tg1 is set as each intersection position of two diagonal lines.

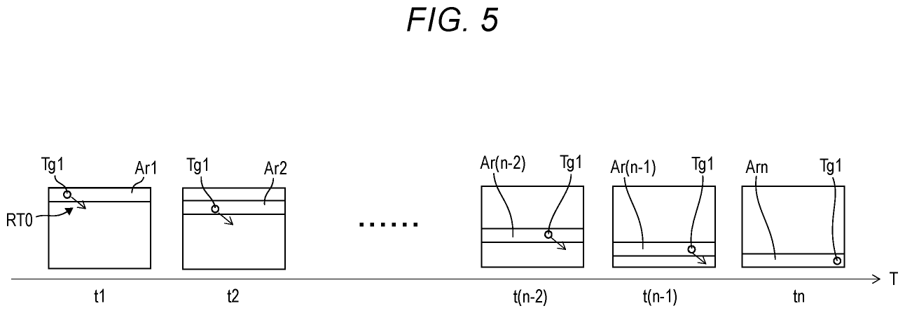

FIG. 5 is a diagram showing an example of a temporal change in the capturing target Tg1 appearing in each of the plurality of limitation ranges Ar1 to Arn. A horizontal axis shown in FIG. 5 indicates time T. The capturing target Tg1 in FIG. 5 does not move from a predetermined position in the capturing range IA1. A vector RT0 indicates a position of the capturing target Tg1 in the next frame.

The camera 3 captures the capturing target Tg1 while moving at a predetermined speed in a direction opposite to the vector RT0 by the drive unit 22. The capturing target Tg1 at a time t1 is positioned in the limitation range Ar1. The capturing target Tg1 at a time t2 is positioned in the limitation range Ar2. The capturing target Tg1 at a time t(n−2) is positioned in the limitation range Ar(n−2). The capturing target Tg1 at a time t(n−1) is positioned in the limitation range Ar(n−1). The capturing target Tg1 at a time to is positioned in the limitation range Arn.

As described above, the prediction unit 43 in the image processing device 4 can predict the position of the capturing target Tg1 in the capturing range IA1 based on the information enabling estimation of the position of the camera 3 and the position information of the capturing target Tg1 received from the actuator 2. The detection unit 44 limitedly reads, based on the predicted position, the limitation range including the predicted position of the capturing target Tg1 among the plurality of limitation ranges Ar1 to Arn. Accordingly, the image processing device 4 can perform image processing in a limited and efficient manner on the limitation range with respect to the capturing range IA1, and thus can reduce the time and load required for the image processing.

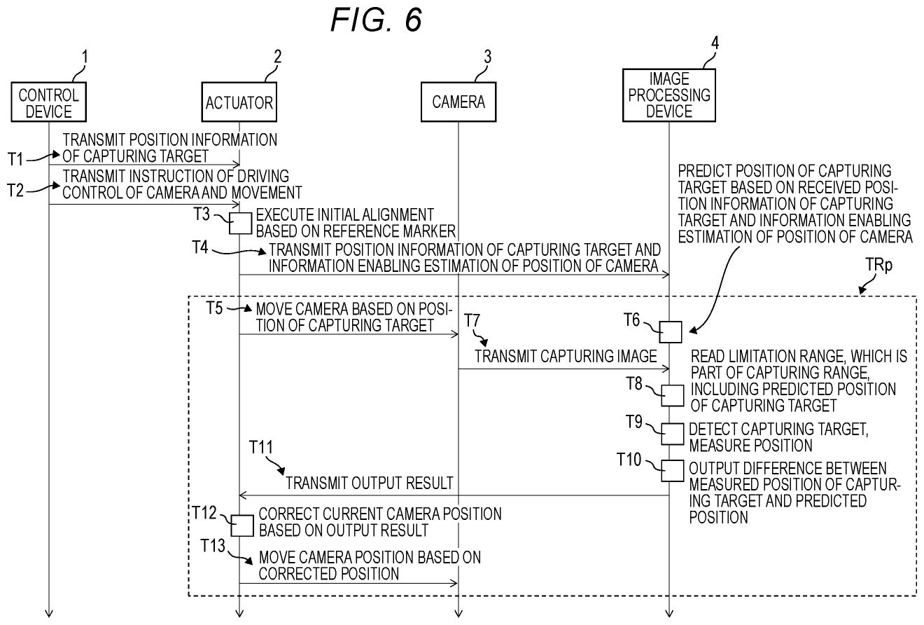

FIG. 6 is a sequence diagram showing an example of an operation procedure of the image processing system according to the first embodiment.

The control device 1 generates a control signal based on the area data 12 input by the user, and transmits the control signal to the actuator 2. Specifically, the control device 1 transmits the position information of the capturing target Tg1 to the actuator 2 based on the area data 12 (T1).

The control device 1 generates a control signal for controlling driving of the camera 3 and a control signal for instructing movement based on the position information of the capturing target Tg1, and transmits the control signal to the actuator 2 (T2).

The actuator 2 executes initial alignment based on the reference marker Pt0 (T3). Specifically, the actuator 2 moves the camera 3 to the capturing position of the reference marker Pt0. After the movement, the actuator 2 causes the camera 3 to capture the reference marker Pt0, and transmits the position information of the reference marker Pt0 to the image processing device 4. The camera 3 transmits the captured image of the reference marker Pt0 to the image processing device 4. The image processing device 4 detects the reference marker Pt0 based on the received captured image, and measures the position of the reference marker Pt0. The image processing device 4 calculates a difference between the measured position and the position of the reference marker Pt0 received from the actuator 2, and transmits the difference to the actuator 2. The actuator 2 corrects the position of the camera 3 based on the received difference.

The actuator 2 transmits the position information of the capturing target Tg1 received from the control device 1 to the image processing device 4 (T4).

The actuator 2 moves the camera 3 to a position where the capturing target Tg1 can be captured based on the position information of the capturing target Tg1 (T5).

The image processing device 4 predicts the position of the capturing target Tg1 appearing in the captured image having the capturing range IA1 based on the received position information of the capturing target Tg1 and information enabling estimation of the position of the camera 3 (for example, the position information of the camera 3, and the moving speed information of the camera 3) (T6).

The camera 3 transmits the captured image having the capturing range IA1 in which the capturing target Tg1 is captured to the image processing device 4 (T7).

The image processing device 4 limitedly reads the limitation range including the predicted position from among the plurality of limitation ranges Ar1, Arn, which are parts of the capturing range IA1, based on the predicted position of the capturing target Tg1 (T8).

The image processing device 4 detects the capturing target Tg1 from the read limitation range, and measures the position of the detected capturing target Tg1 (T9).

The image processing device 4 outputs a difference between the measured position of the capturing target Tg1 and the predicted position (T10).

The image processing device 4 transmits an output result (difference information) to the actuator 2 (T11).

The actuator 2 corrects a current position of the camera 3 based on the output result (difference information) (T12).

The actuator 2 moves the camera 3 to the next position based on the corrected position information of the camera 3 and the position information of the capturing target Tg1 (T13).

After executing the operation processing in step T13, the actuator 2 returns to the operation processing in step T5, and repeats the operation processing of repeat processing TRp from step T5 to step T13 until the capturing target Tg1 is changed. In the operation procedure shown in FIG. 4, when the capturing target Tg1 is changed to another capturing target, the processing in step T3 may be omitted.

The procedure of the steps shown in the sequence diagram is not limited to the order described above. For example, the operation procedures executed in step T6 and step T7 may be reversed.

As described above, the image processing system according to the first embodiment can shorten the time required for the read processing and set the frame rate of the camera 3 faster by limiting the reading of the image in the image processing device 4 to the limitation range. Accordingly, the image processing system according to the first embodiment can obtain a larger number of samplings (in other words, the number of pieces of error information to be output) in the same time, and thus the accuracy of the position error correction can be made higher.

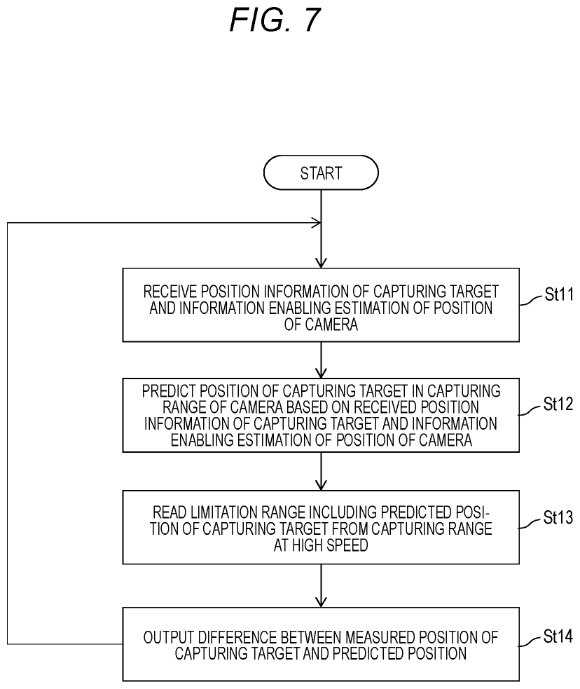

FIG. 7 is a flowchart showing an example of a basic operation procedure of the image processing device 4 according to the first embodiment.

The reception unit 42 receives, from the actuator 2, the position information of the capturing target Tg1 and information enabling estimation of the position of the camera 3 (for example, the position information of the camera 3, and the moving speed information of the camera 3) (St11).

The prediction unit 43 predicts the position of the capturing target Tg1 appearing in the captured image of the camera 3 having the capturing range IA1 based on the received position information of the capturing target Tg1 and the information enabling estimation of the position of the camera 3 (St12).

Based on the predicted position of the capturing target Tg1, the detection unit 44 reads the limitation range including the predicted position from among the plurality of limitation ranges Ar1, Arn, which are parts of the capturing range IA1, at a high speed (St13).

The detection unit 44 detects the capturing target Tg1 from the read limitation range, and measures the position of the detected capturing target Tg1. The detection unit 44 outputs a difference between the measured position of the capturing target Tg1 and the predicted position (St14).

After executing the processing in step St14, the image processing device 4 returns to the processing in step St12. The operation of the image processing device 4 shown in FIG. 7 is repeatedly executed until the instruction of the user (for example, until the capturing target Tg1 is changed to another capturing target or until the difference is output a predetermined number of times) or until the operation of the program stored in the area data 12 is ended.

As described above, the image processing device 4 according to the first embodiment can shorten the time required for the read processing and set the frame rate of the camera 3 faster by limiting the reading of the image to the limitation range. Accordingly, the image processing device 4 according to the first embodiment can obtain a larger number of samplings (in other words, the number of pieces of error information to be output) in the same time, and thus the accuracy of the position error correction can be made higher.

### Second Embodiment

In a second embodiment, in addition to the first embodiment, an image processing system including each of a plurality of cameras having different capturing ranges will be described. The image processing device 4 according to the second embodiment can output an error in a moving speed of the camera or an error in a moving position of the camera based on feature points extracted from a predetermined limitation range in the capturing range. The configuration of the image processing system according to the second embodiment is substantially the same as that of the image processing system according to the first embodiment. Therefore, for the same configuration, the same reference numerals are given to simplify or omit the description, and different contents will be described.

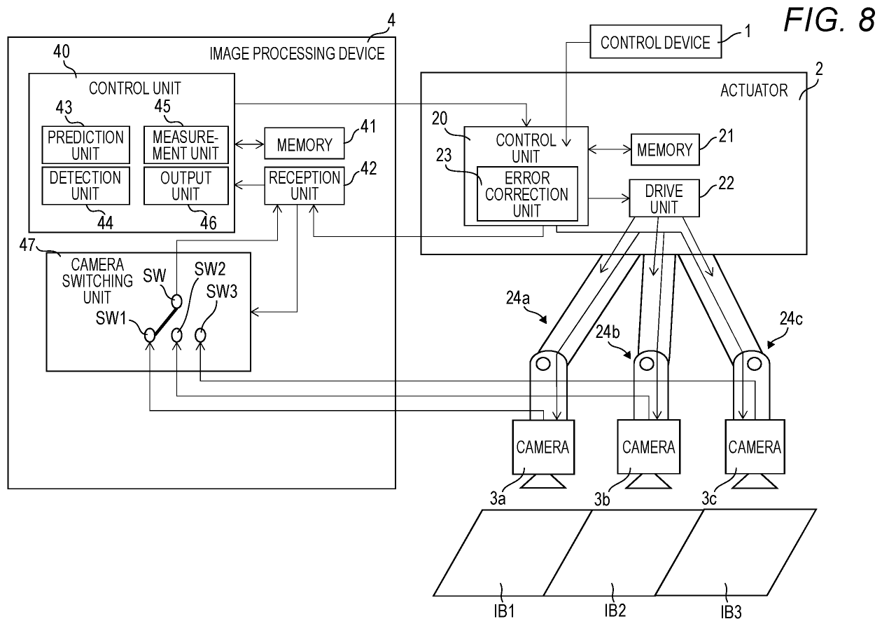

FIG. 8 is an explanatory diagram of an example of a use case of the image processing system including each of the plurality of cameras 3a, 3b, and 3c according to the second embodiment. Since an internal configuration of the control device 1 according to the second embodiment shown in FIG. 8 is the same as the configuration shown in FIG. 1, a simplified diagram is shown. In the actuator 2 and the image processing device 4 according to the second embodiment, the same contents as those described in the first embodiment will be simplified or omitted, and different contents will be described.

The control unit 20 outputs a control signal to each of the plurality of cameras 3a, 3b, and 3c based on the data and the program stored in the area data 12. The control unit 20 outputs the control signal for moving each of the plurality of cameras 3a, 3b, and 3c to the drive unit 22 based on the data and the program stored in the area data 12. Although the number of cameras shown in FIG. 8 is three, it is needless to say that the number of cameras is not limited to three.

The control unit 20 transmits information of the camera to be captured and information enabling estimation of the position of the camera (for example, position information of the camera, and moving speed information of the camera) to the reception unit 42 of the image processing device 4.

The memory 21 stores the arrangement of each of the plurality of cameras 3a, 3b, and 3c and each of capturing ranges IB1, IB2, and IB3.

Each of the plurality of arm units 24a, 24b, and 24c includes each of the plurality of cameras 3a, 3b, and 3c, and is controlled by the drive unit 22. For example, each of the plurality of cameras 3a, 3b, and 3c may be installed in one arm unit 24a.

Each of the plurality of cameras 3a, 3b, and 3c moves in conjunction with the driving of each of the plurality of arm units 24a, 24b, and 24c based on the control of the drive unit 22. Each of the plurality of cameras 3a, 3b, and 3c is installed so as to be able to capture different capturing ranges. The camera 3a has the capturing range IB1. The camera 3b has the capturing range IB2. The camera 3c has the capturing range IB3.

The operation of each of the plurality of cameras 3a, 3b, and 3c is the same as that of camera 3 according to the first embodiment, and thus the description thereof will be omitted.

The plurality of capturing ranges IB1, IB2, and IB3 are different capturing ranges. Although each of the plurality of capturing ranges IB1, IB2, and IB3 shown in FIG. 8 is shown as adjacent capturing ranges, each of the plurality of capturing ranges IB1, IB2, and IB3 moves according to the position of each of the plurality of cameras 3a, 3b, and 3c.

The image processing device 4 further includes a camera switching unit 47 in addition to the components of the image processing device 4 according to the first embodiment.

The reception unit 42 outputs various kinds of information of the camera received from the actuator 2 to the prediction unit 43, the detection unit 44, the output unit 46, and the camera switching unit 47. The various kinds of information include a frame rate of each of the plurality of cameras 3a, 3b, and 3c, information related to each of the plurality of capturing ranges IB1, IB2, and IB3, zoom magnification information of each of the plurality of cameras 3a, 3b, and 3c, and the like.

The detection unit 44 according to the second embodiment does not set a capturing target in an initial state, and extracts feature points described below.

The detection unit 44 reads a predetermined limitation range set in a first frame from among at least two frames continuously captured, and extracts each of a plurality of feature points having a predetermined feature amount. The detection unit 44 extracts a capturing target Tg2 as one feature point having a large feature amount among the plurality of extracted feature points. When the feature point cannot be extracted in the first frame, the detection unit 44 corrects another limitation range or the limitation range, executes the reading again, and extracts the feature point (capturing target). The correction of the limitation range is executed by the detection unit 44 based on a distribution of each of the extracted plurality of feature points. The correction of the limitation range is executed, for example, by expanding or shifting the limitation range in a direction in which a density (degree of density) of the feature points is high among the distributions of the plurality of feature points in the limitation range.

The detection unit 44 reads the same limitation range in a second frame after the extraction of the capturing target Tg2, and detects the capturing target Tg2. When the capturing target Tg2 cannot be detected in the second frame, the detection unit 44 corrects another limitation range or the limitation range and executes the reading again. The detection unit 44 may set the capturing target Tg2 as the capturing target.

The predetermined feature amount described above is set in advance by the user and is stored in the memory 11 of the control device 1. The image processing device 4 receives information on a predetermined feature amount from the control device 1 via the actuator 2.

The measurement unit 45 measures a position Pt1 of the capturing target Tg2 appearing in the first frame (that is, a first captured image) and a position Pt1 of the capturing target Tg2 appearing in the second frame (that is, a second captured image).

The output unit 46 calculates a movement speed of the capturing target Tg2 based on a movement amount of the capturing target Tg2 measured based on each of the two frames and the frame rate of each of the plurality of cameras 3a, 3b, and 3c received by the reception unit 42. The output unit 46 outputs a speed difference between the calculated movement speed of the capturing target Tg2 and the moving speed of the camera that captures the capturing target Tg2 or the actuator 2. The output unit 46 transmits an output result to the error correction unit 23 in the actuator 2.

The error correction unit 23 outputs, to the drive unit 22, a control signal for correcting a speed error of the camera that captures the image of the capturing target Tg2 based on the received speed difference.

The camera switching unit 47 includes any one of a plurality of switches SW1, SW2, and SW3 connected to the plurality of cameras 3a, 3b, and 3c, respectively, and a switch SW for outputting the captured image to the reception unit 42. The camera switching unit 47 switches each of the plurality of switches SW1, SW2, and SW3 (that is, each of the plurality of cameras 3a, 3b, and 3c) connected to the switch SW based on the predicted position of the capturing target Tg2 predicted by the prediction unit 43 or the control signal input from the control unit 20.

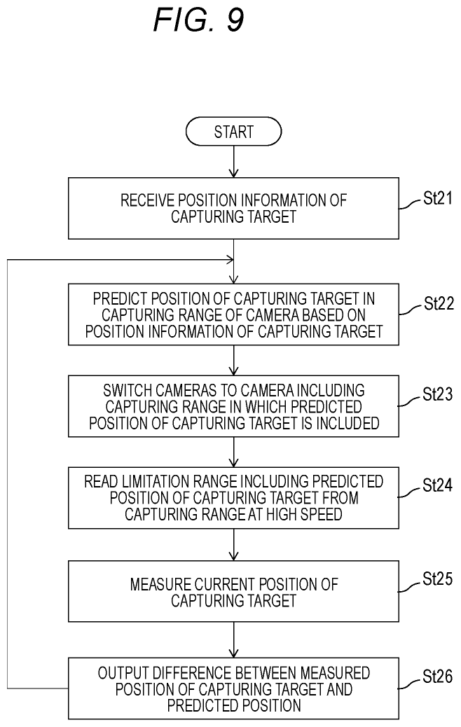

FIG. 9 is a flowchart showing an example of an operation procedure of the image processing device 4 including each of the plurality of cameras 3a, 3b, and 3c according to the second embodiment. In the flowchart shown in FIG. 9, an capturing target is set in the image processing device 4.

The reception unit 42 receives, from the actuator 2, position information of a capturing target (not shown), information of any one of the plurality of cameras 3a, 3b, and 3c that capture images of the capturing target, and information enabling estimation of the positions of the plurality of cameras 3a, 3b, and 3c (for example, position information of each of the plurality of cameras 3a, 3b, and 3c, and moving speed information of each of the plurality of cameras 3a, 3b, and 3c) (St21).

The prediction unit 43 predicts the position at which the capturing target is reflected on the image sensor of the camera that captures the capturing target based on the received position information of the capturing target, the information of the camera that captures the capturing target, and the information enabling estimation of the position of the camera (St22).

The camera switching unit 47 switches the switch connected to the switch SW based on the received information of the camera that captures the capturing target (St23).

Based on the predicted position of the capturing target on the image sensor, the detection unit 44 reads a limitation range including the predicted position from among predetermined limitation ranges, which are parts of the capturing range, at a high speed (St24).

The detection unit 44 detects a capturing target having the predetermined feature amount from the read captured image in the limitation range. The measurement unit 45 measures the detected position of the capturing target (St25).

The output unit 46 outputs a difference between the measured position on the captured image of the capturing target and the predicted position on the image sensor (St26).

After executing the processing in step St26, the image processing device 4 returns to the processing in step St22. The operation of the image processing device 4 shown in FIG. 7 is repeatedly executed until the capturing target is changed to another capturing target or until the operation of the program stored in the area data 12 is ended.

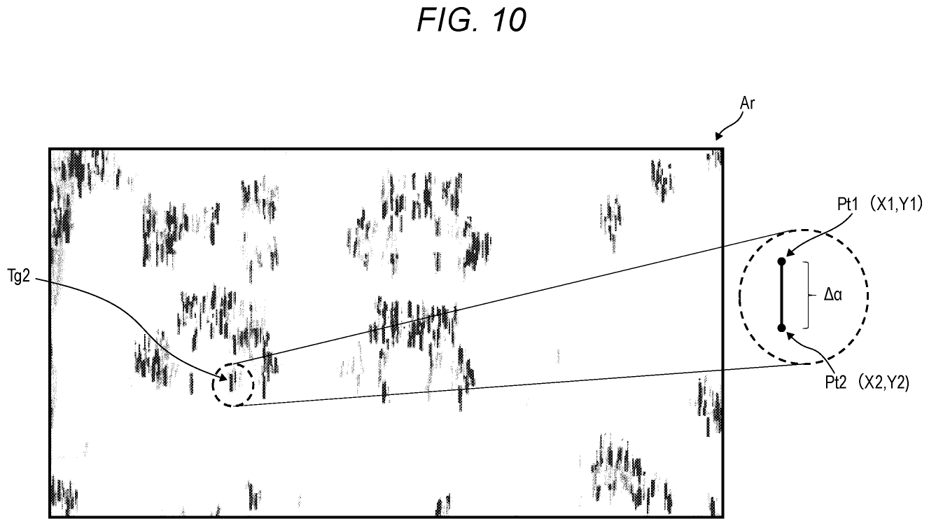

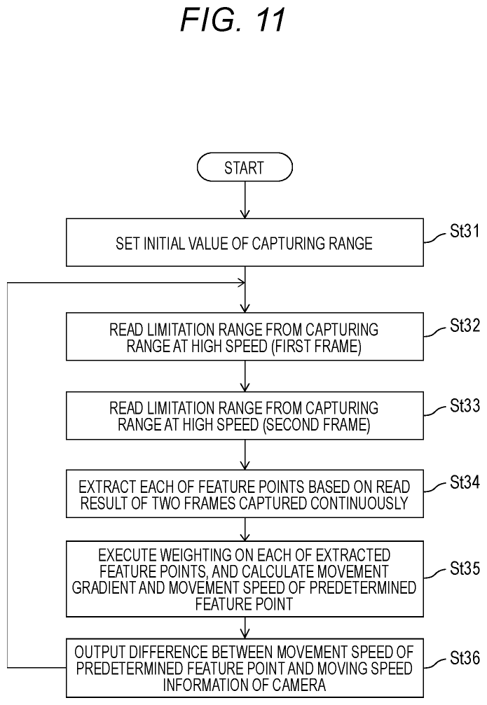

In the following description, an image processing system in which the capturing target is not set in advance and feature points are extracted by image processing will be described with reference to FIGS. 10 and 11.

As described above, the image processing device 4 according to the second embodiment can shorten the time required for the reading processing and set the frame rate of the camera faster by limiting the reading of the image to the limitation range. Accordingly, the image processing device 4 according to the second embodiment can obtain a larger number of samplings (in other words, the number of pieces of error information to be output) in the same time, and thus the accuracy of the position error correction can be made higher.

FIG. 10 is a diagram showing an example of detection of the feature point (capturing target Tg2). FIG. 11 is a flowchart showing an example of an operation procedure of the image processing device 4 according to the second embodiment that detects the feature point (capturing target Tg2).

The image shown in FIG. 10 is an image obtained by extracting the movement of each of a plurality of feature points appearing in the captured image between two frames that are continuously captured and read in the same limitation range Ar, and shows a state in which the capturing target Tg2 as the feature point is extracted from each of the plurality of feature points. The image shown in FIG. 10 is generated by processing executed in step St34 of FIG. 11 to be described later.

For example, the capturing target Tg2 is positioned at a position Pt1 indicated by coordinates (X1, Y1) in the captured image in the first frame and is positioned at a position Pt2 indicated by coordinates (X2, Y2) in the captured image in the second frame by each of the plurality of cameras 3a, 3b, and 3c which are high-speed cameras. A movement amount Aa of the capturing target Tg2 is indicated by a change in coordinates between the position Pt1 and the position Pt2 or a magnitude of a vector from the position Pt1 to the position Pt2.

Next, a detection procedure of the capturing target Tg2 will be described with reference to a flowchart shown in FIG. 11.

The reception unit 42 receives information related to the camera, such as the capturing range, the moving speed, the frame rate, and the zoom magnification of the camera, from the actuator 2, and outputs the information to the detection unit 44, the measurement unit 45, and the output unit 46. The detection unit 44 sets the capturing range of the camera based on the input information on the camera (St31).

The detection unit 44 reads a predetermined limitation range from the capturing range captured in the first frame from among the two frames captured most recently and continuously at a high speed (St32).

The detection unit 44 reads a predetermined limitation range from the capturing range captured in the second frame from among the two frames captured most recently and continuously at a high speed (St33).

The limitation range in which the reading is executed may be any one of the plurality of limitation ranges Ar1 to Arn set in advance from the actuator 2 as described with reference to FIG. 4, or may be a limitation range set by the user.

The detection unit 44 detects each of the plurality of feature points appearing in the read captured image of the limitation range based on the read result in each of the two frames captured most recently and continuously (St34).

The detection unit 44 executes weighting (extraction of the feature amount) on each of the plurality of feature points detected in step St34, and extracts the predetermined capturing target Tg2 having the predetermined feature amount from each of the plurality of feature points. The measurement unit 45 measures a movement amount Aa (for example, a positional difference between based on the positions Pt1 and Pt2 of the capturing target Tg2 on the read captured image shown in FIG. 10) with respect to the extracted predetermined capturing target Tg2. The output unit 46 calculates the movement speed of the predetermined capturing target Tg2 based on the frame rate of the camera received from the actuator 2 and the measured movement amount Aa (St35).

The output unit 46 outputs a difference between the calculated movement speed of the predetermined capturing target Tg2 and the moving speed of the camera, and transmits the output speed difference to the actuator 2 (St36).

After executing the processing in step St36, the image processing device 4 returns to the processing in step St32, and extracts each of the plurality of feature points having the predetermined feature amount from the same limitation range.

When the feature point having the predetermined feature amount is not obtained from the limitation range as a result of executing the processing in step St35, the limitation range to be read may be changed to another limitation range, and the processing shown in step St32 and subsequent steps may be executed again.

As described above, the image processing device 4 according to the second embodiment can shorten the time required for the reading processing and set the frame rate of the camera faster by limiting the reading of the image to the limitation range. Accordingly, the image processing device 4 according to the second embodiment can obtain a larger number of samplings (in other words, the number of pieces of error information to be output) in the same time, and thus the accuracy of the speed error correction can be made higher.

(Other Modifications)

In other modifications, as an application example of the second embodiment, an image processing system in which an actuator is a drone capable of flight control will be described. The image processing system according to other modifications detects another feature point in another limitation range while tracking a feature point detected from a predetermined limitation range. The configuration of the image processing system according to other modifications is substantially the same as that of the image processing system according to the second embodiment.

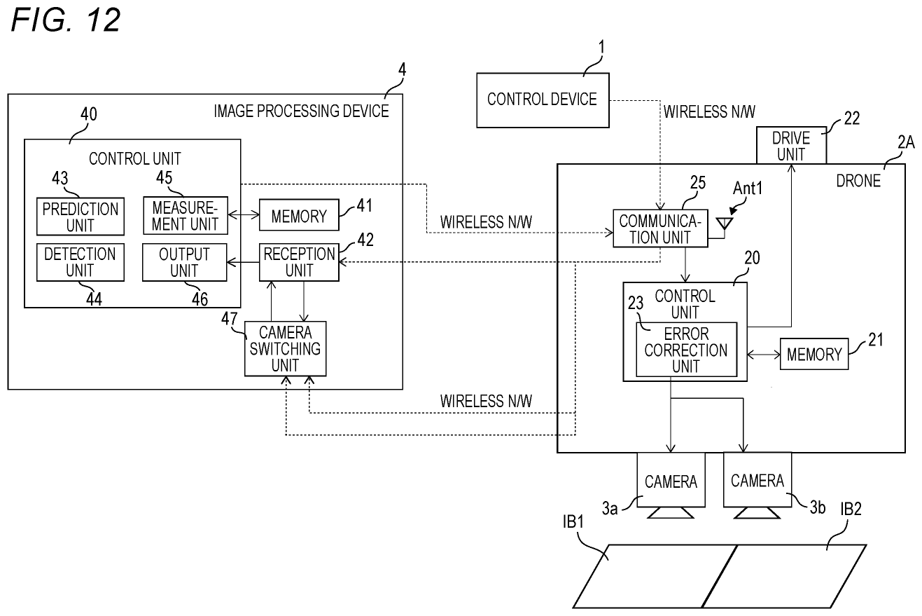

FIG. 12 is an explanatory diagram of an example of a use case of the image processing system including a drone 2A. An internal configuration of the control device 1 in other modifications shown in FIG. 12 is the same as the configuration shown in FIG. 1, and thus a simplified diagram is shown. In the control device 1 according to other modifications, same contents as those described in the first embodiment will be simplified or omitted, and different contents will be described.

The control device 1 in other modifications is, for example, a proxy (so-called remote controller) used by an operator (user) of the drone 2A, and remotely controls the flight of the drone 2A based on the area data 12. The control device 1 is connected to the drone 2A by wireless N/W, and generates and transmits a control signal for controlling the flight of the drone 2A based on the area data 12.

The area data 12 in other modifications is constituted to include, for example, information on a flight path along which the drone 2A flies.

The control device 1 may be operated by the user. In such a case, the control device 1 remotely controls the flight of the drone 2A based on the operation of the user. The control device 1 is connected to the drone 2A by the wireless N/W, and generates and transmits the control signal related to the flight control of the drone 2A.

The drone 2A is, for example, an unmanned aerial vehicle, and flies based on a control signal transmitted from the control device 1 in response to an input operation of the user. The drone 2A includes a plurality of cameras 3a and 3b. The drone 2A includes a control unit 20, a memory 21, a drive unit 22, an error correction unit 23, and a communication unit 25.

The communication unit 25 includes an antenna Ant1, is connected to the control device 1 and the image processing device 4 via the wireless N/W (for example, a wireless communication network using Wifi (registered trademark)), and transmits and receives information and data.

The communication unit 25 receives, for example, a signal related to control of a moving direction, a flight altitude, and the like of the drone 2A through communication with the control device 1. The communication unit 25 transmits a satellite positioning signal indicating the position information of the drone 2A received by the antenna Ant1 to the control device 1. The antenna Ant1 will be described later.

The communication unit 25 transmits, for example, setting information related to a feature amount necessary for extraction of the feature point, setting information of each of the plurality of cameras 3a and 3b (for example, information related to the capturing range, the frame rate, the zoom magnification, and the limitation range), speed information of the drone 2A, and the like through communication with the image processing device 4. Through communication with the image processing device 4, the communication unit 25 receives difference (error) information related to the speed between the speed information of the drone 2A and the movement speed of the capturing target Tg2 appearing in the captured image captured by each of the plurality of cameras 3a and 3b. The communication unit 25 outputs the received difference (error) information to the error correction unit 23.

The antenna Ant1 is, for example, an antenna capable of receiving the satellite positioning signal transmitted from an artificial satellite (not shown). A signal that can be received by the antenna Ant1 is not limited to a global positioning system (GPS) signal of the United States, and may be a signal transmitted from an artificial satellite that can provide a satellite positioning service such as a global navigation satellite system (GLONASS) of Russia or Galileo of Europe. The antenna Ant1 may receive a satellite positioning signal transmitted by an artificial satellite that provides the satellite positioning service described above, and a quasi-zenith satellite signal that transmits a satellite positioning signal that can be augmented or corrected.

The drive unit 22 drives the drone 2A to fly based on the control signal received from the control device 1 via the communication unit 25. The drive unit 22 is at least one rotary wing, and flies by controlling lift generated by rotation. Although the drive unit 22 is shown on a ceiling surface of the drone 2A in FIG. 12, an installation place is not limited to the ceiling surface, and may be a place where the drone 2A can be subjected to flight control, such as a lower portion or a side surface of the drone 2A.

The error correction unit 23 corrects a flight speed of the drive unit 22 based on the speed difference (error) information between the flight speed of the drone 2A and the movement speed of the capturing target Tg3 received from the output unit 46 in the image processing device 4.

Each of the plurality of cameras 3a and 3b is a camera that captures different capturing ranges IB1 and IB2. Each of the plurality of cameras 3a and 3b may be fixedly installed in the drone 2A, or may be installed so as to be able to capture images at various angles. Each of the plurality of cameras 3a and 3b may be provided at any place among the side surface, the bottom surface, and the ceiling surface of the drone 2A. For example, each of the plurality of cameras 3a and 3b may be installed on different surfaces such as the ceiling surface and the bottom surface of the drone 2A or different side surfaces.

Each of the capturing ranges IB1 and IB2 shown in FIG. 12 is a continuous capturing range, but may be changed based on the installation place of each of the plurality of cameras 3a and 3b, and the capturing ranges may not be continuous.

Each of the plurality of cameras 3a and 3b transmits the captured image to the camera switching unit 47 in the image processing device 4 via the communication unit 25.

Through communication with the drone 2A, the reception unit 42 receives setting information related to each of the plurality of cameras 3a and 3b, such as the frame rate and the capturing range of each of the plurality of cameras 3a and 3b, and each of a plurality of limitation ranges set on the image sensor, and setting information related to the captured image and the feature point captured by each of the plurality of cameras 3a and 3b (for example, the feature amount necessary for detecting the feature point in a read limitation range of the captured image).

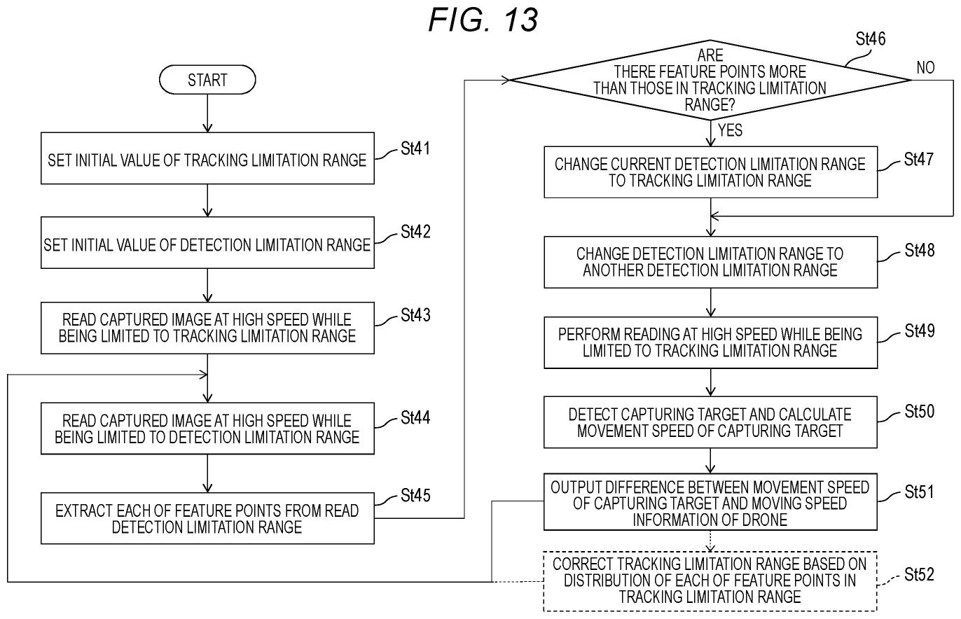

The detection unit 44 sets a tracking limitation range for tracking the capturing target Tg3 in the image sensor and a detection limitation range for detecting another capturing target (denoted as a detection limitation range in FIG. 13) based on the setting information of each of the plurality of cameras 3a and 3b received by the reception unit 42. The detection unit 44 may set a tracking camera for tracking the capturing target Tg3 and a detection camera for detecting another capturing target Tg4, set a tracking limitation range (described as a tracking limitation range in FIG. 13) for tracking the capturing target Tg3 with respect to the tracking camera, and set a detection limitation range for detecting another capturing target Tg4 with respect to the detection camera.

In the detection unit 44 in other modifications, the capturing target Tg3 is not set in an initial state. Therefore, the setting of the capturing target Tg3 will be described below.

The detection unit 44 reads a captured image in the tracking limitation range set on the image sensor, and extracts each of the plurality of feature points having the predetermined feature amount. The detection unit 44 sets one feature point including a large amount of feature amounts among the plurality of extracted feature points as the capturing target Tg3.

The detection unit 44 reads a captured image in the detection limitation range set on the image sensor, and extracts each of the plurality of feature points having the predetermined feature amount. The detection unit 44 determines whether each of the plurality of feature points included in the detection limitation range is larger than each of the plurality of feature points included in the tracking limitation range. The detection unit 44 may perform the determination based on the feature amount of the feature point having the largest feature amount among each of the plurality of feature points included in the detection limitation range and the feature amount of the capturing target Tg3. As a result of the determination, the detection unit 44 sets a limitation range including the feature point having a larger number of each of the plurality of feature points or including a larger feature amount as the tracking limitation range. Further, the detection unit 44 sets another limitation range as the detection limitation range. The image processing device 4 executes the same processing even when the tracking camera and the detection camera are set by the detection unit 44.

The detection unit 44 may correct the tracking limitation range based on the distribution of each of the plurality of feature points included in the tracking limitation range. Accordingly, when there is a feature point having a larger feature amount in the vicinity of a boundary of a tracking capturing range of the capturing target Tg3, the detection unit 44 can set the capturing target Tg3 as another capturing target Tg4.

The prediction unit 43 predicts the position of the capturing target Tg3 on the image sensor captured in the next two frames based on the detected movement amount of the capturing target Tg3 and the flight direction of the drone 2A. The prediction unit 43 outputs the predicted position of the capturing target Tg3 to the detection unit 44.

When the predicted position is shifted to the capturing range of another camera or the limitation range of another camera, the prediction unit 43 may output information on the limitation range set on the camera of a shift destination or the image sensor of the camera of the shift destination to the detection unit 44 and the camera switching unit 47. Further, when the predicted position of the capturing target Tg3 is positioned outside the capturing range, the prediction unit 43 may output to the detection unit 44 and the camera switching unit 47 that the predicted position of the capturing target Tg3 moves outside the capturing range.

The output unit 46 calculates the movement speed of the capturing target Tg3 based on the position of the capturing target Tg3 in the captured image measured by the measurement unit 45. The calculation of the movement speed will be described in detail together with the description of the flowchart shown in FIG. 13. The output unit 46 transmits the speed difference between the flight speed of the drone 2A and the movement speed of the capturing target Tg3 received by the reception unit 42 to the error correction unit 23 via the communication unit 25.

The camera switching unit 47 switches the cameras that capture the set tracking limitation range and the set detection limitation range for each frame, and does not switch the cameras when the set tracking limitation range and the set detection limitation range are within the capturing range of the same camera. The camera switching unit 47 similarly executes camera switching for each frame even when the tracking camera and the detection camera are set for each of the plurality of cameras 3a and 3b.

FIG. 13 is a flowchart showing an example of a tracking and detection operation procedure of the image processing device 4 according to the second embodiment. In the description of the flowchart shown in FIG. 13, an example of the operation procedure of the image processing device 4 when the image processing device 4 receives the image data from each of the plurality of cameras 3a and 3b included in the drone 2A shown in FIG. 12 will be described, whereas the number of cameras is not limited to two, and may be three or more, or may be one when an angle of view of the cameras is not fixed.

The reception unit 42 receives setting information of each of the plurality of cameras 3a and 3b, such as the frame rate, the capturing range, and the limitation range of each of the plurality of cameras 3a and 3b, and setting information related to the feature point (for example, the feature amount necessary for detecting the feature point) through wireless communication with the drone 2A. The camera switching unit 47 sets the tracking limitation range based on the setting information of each of the plurality of cameras 3a and 3b received by the reception unit 42 (St41). When one of the plurality of cameras 3a and 3b is set as the tracking camera, the limitation range in the capturing range of the tracking camera is set as the tracking limitation range.

The camera switching unit 47 sets the detection limitation range based on the setting information of each of the plurality of cameras 3a and 3b received by the reception unit 42 (St42). When one of the plurality of cameras 3a and 3b is set as the detection camera by the user, the limitation range in the capturing range of the detection camera is set as the detection limitation range. The number of the detection limitation range and the detection camera may be a plurality of instead of one.

The camera switching unit 47 switches the connection of the switch SW to the set tracking limitation range (in other words, the camera including a detection range for tracking in the capturing range). The reception unit 42 is switched by the camera switching unit 47, receives the captured image from the connected camera, and outputs the captured image to the detection unit 44. The detection unit 44 reads the set tracking limitation range in the input capturing range in a limited manner at high speed (St43).

The camera switching unit 47 switches the connection of the switch SW to the set detection limitation range (in other words, the camera including a detection range for detection in the capturing range). The reception unit 42 is switched by the camera switching unit 47, receives the captured image from the connected camera, and outputs the captured image to the detection unit 44. The detection unit 44 reads the set detection limitation range in the input capturing range in a limited manner at high speed (St44).

The detection unit 44 extracts each of the plurality of feature points (capturing targets) having a predetermined feature amount from the read captured image in the detection limitation range (St45).

The detection unit 44 compares each of the plurality of feature points in the tracking limitation range extracted in the processing of step St44 with each of the plurality of feature points in the detection limitation range extracted in the processing of step St45, and determines whether each of the plurality of feature points included in the detection limitation range is larger than each of the plurality of feature points included in the tracking limitation range (St46). A determination method may be the number of feature points or a magnitude of a maximum feature amount of the feature point in each limitation range.

As a result of the determination in step St46, when each of the plurality of feature points included in the detection limitation range is larger than each of the plurality of feature points included in the tracking limitation range (St46, YES), the detection unit 44 causes the camera switching unit 47 to change the current tracking limitation range to the detection limitation range and to change the current detection limitation range to the tracking limitation range (St47).

As a result of the determination in step St46, when each of the plurality of feature points included in the detection limitation range is smaller than each of the plurality of feature points included in the tracking limitation range (St46, NO), or after the processing in step St47 is executed, the camera switching unit 47 changes the current detection limitation range to another limitation range (specifically, a limitation range other than the limitation range that is not set as the tracking limitation range and includes the predicted position of the capturing target) (St48).

The camera switching unit 47 switches the connection of the switch SW to the set tracking limitation range. The reception unit 42 outputs the frame of the camera switched by the camera switching unit 47 to the detection unit 44. The detection unit 44 reads the set tracking limitation range in the input capturing range in a limited manner at high speed (St49).

The detection unit 44 extracts each of the plurality of feature points from the captured image in the tracking limitation range read by executing the processing in step St43. The detection unit 44 sets one feature point among the plurality of extracted feature points as the capturing target Tg3, and detects the capturing target Tg3 from the captured image in the tracking limitation range read by executing the processing in step St49. The measurement unit 45 measures the position of the capturing target Tg3 detected in step St43 and the position of the capturing target Tg3 detected in step St49 based on the setting information of each of the plurality of cameras 3a and 3b received by the reception unit 42. The output unit 46 calculates the movement speed of the capturing target Tg3 based on the measured difference between the position of the capturing target Tg3 detected in step St43 and the position of the capturing target Tg2 detected in step St49 (St50).

Here, the movement speed of the capturing target calculated in step St50 will be described.

When each of the plurality of feature points included in the detection limitation range is larger than each of the plurality of feature points included in the tracking limitation range in step St46 (St46, YES), the detection unit 44 changes the current detection limitation range to the tracking limitation range by the processing in step St47, and reads the same limitation range as that in step St44 by the processing in step St49. Therefore, in order to continuously read the same limitation range, the output unit 46 calculates the movement speed of the capturing target based on the position of the capturing target changed between two frames.

On the other hand, when each of the plurality of feature points included in the detection limitation range is not larger than each of the plurality of feature points included in the tracking limitation range in step St46 (St46, NO), the detection unit 44 reads the same tracking limitation range as in step St43 by the processing in step St49. In such a case, the detection unit 44 reads another limitation range once in step St44. Therefore, the position of the capturing target (feature point) detected in step St49 is the position of the capturing target two frames after the capturing target detected in step St44. Therefore, the output unit 46 calculates the movement speed of the capturing target based on the position of the capturing target changed during three frames in order to read another limitation range once.

The output unit 46 outputs the speed difference between the speed information of the drone 2A input from the reception unit 42 and the movement speed of the capturing target Tg3, and transmits the difference to the drone 2A (St51).

After executing the processing in step St51, the image processing device 4 returns to the processing in step St44. The detection unit 44 in the processing in step St46 after a second round detects another capturing target Tg4 including a feature amount larger than that of the current capturing target Tg3. When the capturing target Tg3 is positioned outside the capturing range of each of the plurality of cameras 3a and 3b, the detection unit 44 may return to the processing in step St41.

After executing the processing in step St51, the detection unit 44 may correct the tracking limitation range based on the distribution of each of the plurality of feature points detected in the tracking limitation range (St52). Even in such a case, the image processing device 4 returns to the processing in step St44 after executing the processing in step St52.

As described above, the image processing device 4 according to other modifications can simultaneously track the capturing target Tg3 and detect another capturing target. Accordingly, the drone 2A can obtain the capturing target Tg3 (mark) in the capturing range when executing a posture control in the drone 2A. Further, when the image processing device 4 described above is used, the drone 2A can obtain information related to the posture of the drone 2A by comparing information such as the moving speed or the moving direction of the drone 2A with information of the movement speed or the moving direction (vector) of the capturing target Tg3 (mark).

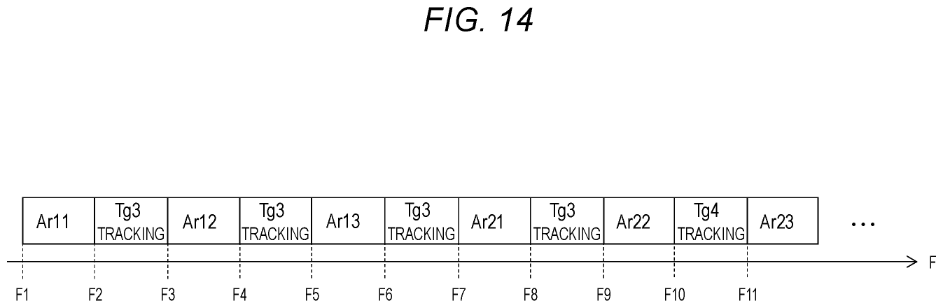

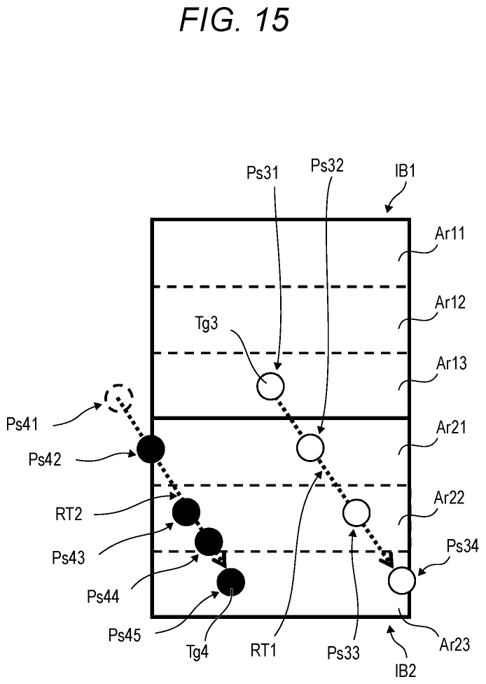

Tracking and detection of the capturing target in other modifications will be described with reference to FIGS. 14 and 15. FIG. 14 is a diagram showing an example of switching between the tracking limitation range and the detection limitation range. A horizontal axis shown in FIG. 14 represents a frame. FIG. 15 is a diagram showing an example of the tracking and the detection of the capturing target. In a frame F1 shown in FIG. 14, the image processing device 4 executes the processing in step St44 after executing the processing up to step St51 or step St52.

FIG. 14 shows a state in which the camera switching unit 47 performs switching between the tracking limitation range based on the predicted position of the capturing target Tg3 and the set detection limitation range for each frame by the prediction unit 43.

Each of the plurality of capturing targets Tg3 and Tg4 shown in FIG. 15 is a feature point extracted by the detection unit 44 and having a predetermined feature amount. The capturing target Tg3 is a feature point that is already extracted by the detection unit 44 and is set as a capturing target at the time of the frame F1. The position of the capturing target Tg3 changes so as to move on a trajectory RT1 for each frame by the flight (movement) of the drone 2A. The capturing target Tg4 is a feature point that is in an undetected state by the detection unit 44 in the initial state and has a predetermined feature amount. The capturing target Tg4 is positioned outside the capturing range of each of the plurality of cameras 3a and 3b in the frame F1. The position of the capturing target Tg4 changes so as to move on a trajectory RT2 for each frame by the flight (movement) of the drone 2A.

In the frame F1, the camera switching unit 47 switches a connection destination of the switch SW to the camera 3a including a detection limitation range Ar11 in the capturing range. The detection unit 44 reads the detection limitation range Ar11 at high speed, and extracts feature points having the predetermined feature amount. Based on an extraction result, the detection unit 44 determines that a feature point exceeding the feature amount of the capturing target Tg3 in the previous tracking limitation range (not shown) is not extracted, and changes the detection limitation range Ar11 to an adjacent detection limitation range Ar12.

In a frame F2, the prediction unit 43 predicts the predicted position of the capturing target Tg3 as a position Ps31 (tracking limitation range Ar13), and outputs a prediction result to the camera switching unit 47 and the detection unit 44. The camera switching unit 47 maintains the connection destination of the switch SW as the camera 3a including the tracking limitation range Ar13 in the capturing range. The detection unit 44 reads the tracking limitation range Ar13 at a high speed, and detects the capturing target Tg3. Based on the detection result, the measurement unit 45 measures the movement amount of the capturing target Tg3 based on the position of the capturing target Tg3 captured in the previous tracking limitation range (not shown) and the position of the capturing target Tg3 captured in a tracking limitation range Ar13. The output unit 46 calculates the movement speed of the capturing target Tg3 based on the measured movement amount of the capturing target Tg3, outputs a speed difference between the movement speed of the capturing target Tg3 and the flight speed of the drone 2A, and transmits the difference to the error correction unit 23 via the communication unit 25.

In a frame F3, the camera switching unit 47 maintains the connection destination of the switch SW as the camera 3a including the detection limitation range Ar12 in the capturing range. The detection unit 44 reads the detection limitation range Ar12 at high speed, and extracts feature points having the predetermined feature amount. Based on the extraction result, the detection unit 44 determines that a feature point exceeding the feature amount of the capturing target Tg3 in the previous tracking limitation range Ar13 is not extracted, and changes the detection limitation range Ar12 to the adjacent detection limitation range Ar13.

In a frame F4, the prediction unit 43 predicts the predicted position of the capturing target Tg3 as a position Ps32 (tracking limitation range Ar21), and outputs a prediction result to the camera switching unit 47 and the detection unit 44. The camera switching unit 47 switches the connection destination of the switch SW to the camera 3b in which the tracking limitation range Ar21 is included in the capturing range. The detection unit 44 reads the tracking limitation range Ar21 at a high speed, and detects the capturing target Tg3. Based on the detection result, the measurement unit 45 measures the movement amount of the capturing target Tg3 based on the position of the capturing target Tg3 captured in the previous tracking limitation range Ar13 and the position of the capturing target Tg3 captured in the tracking limitation range Ar21. The output unit 46 calculates the movement speed of the capturing target Tg3 based on the measured movement amount of the capturing target Tg3, outputs the speed difference between the movement speed of the capturing target Tg3 and the flight speed of the drone 2A, and transmits the difference to the error correction unit 23 via the communication unit 25.

In a frame F5, the camera switching unit 47 switches a connection destination of the switch SW to the camera 3a including the detection limitation range Ar13 in the capturing range. The detection unit 44 reads the detection limitation range Ar13 at high speed, and extracts feature points having the predetermined feature amount. Based on the extraction result, the detection unit 44 determines that a feature point exceeding the feature amount of the capturing target Tg3 in the previous tracking limitation range Ar21 is not extracted, and changes the detection limitation range Ar12 to the adjacent detection limitation range Ar13.

In a frame F6, the prediction unit 43 predicts the predicted position of the capturing target Tg3 as a position Ps33 (tracking limitation range Ar22), and outputs a prediction result to the camera switching unit 47 and the detection unit 44. The camera switching unit 47 switches the connection destination of the switch SW to the camera 3b in which the tracking limitation range Ar22 is included in the capturing range. The detection unit 44 reads the tracking limitation range Ar22 at a high speed, and detects the capturing target Tg3. Based on the detection result, the measurement unit 45 measures the movement amount of the capturing target Tg3 based on the position of the capturing target Tg3 captured in the previous tracking limitation range Ar21 and the position of the capturing target Tg3 captured in the tracking limitation range Ar22. The output unit 46 calculates the movement speed of the capturing target Tg3 based on the measured movement amount of the capturing target Tg3, outputs the speed difference between the movement speed of the capturing target Tg3 and the flight speed of the drone 2A, and transmits the difference to the error correction unit 23 via the communication unit 25.

In a frame F7, the camera switching unit 47 maintains the connection destination of the switch SW as the camera 3b including the detection limitation range Ar21 in the capturing range. The detection unit 44 reads the detection limitation range Ar21 at high speed. The detection unit 44 extracts the capturing target Tg4 as a feature point positioned at a position Ps42 and having a predetermined feature amount. The detection unit 44 compares the capturing target Tg4 in the detection limitation range Ar21 with the capturing target Tg3 in the previous tracking limitation range Ar22 based on the extraction result. As a result of the comparison, the detection unit 44 determines that a feature point exceeding the feature amount of the capturing target Tg3 in the previous tracking limitation range Ar22 is not extracted, and changes the detection limitation range Ar12 to the adjacent detection limitation range Ar13.

In a frame F8, the prediction unit 43 predicts the predicted position of the capturing target Tg3 as a position Ps34 (tracking limitation range Ar23), and outputs a prediction result to the camera switching unit 47 and the detection unit 44. The camera switching unit 47 maintains the connection destination of the switch SW as the camera 3b including the tracking limitation range Ar23 in the capturing range. The detection unit 44 reads the tracking limitation range Ar23 at a high speed, and detects the capturing target Tg3. Based on the detection result, the measurement unit 45 measures the movement amount of the capturing target Tg3 based on the position of the capturing target Tg3 captured in the previous tracking limitation range Ar22 and the position of the capturing target Tg3 captured in the tracking limitation range Ar23. The output unit 46 calculates the movement speed of the capturing target Tg3 based on the measured movement amount of the capturing target Tg3, outputs the speed difference between the movement speed of the capturing target Tg3 and the flight speed of the drone 2A, and transmits the difference to the error correction unit 23 via the communication unit 25.

In a frame F9, the camera switching unit 47 maintains the connection destination of the switch SW as the camera 3b including the detection limitation range Ar22 in the capturing range. The detection unit 44 reads the detection limitation range Ar22 at high speed. The detection unit 44 extracts the capturing target Tg4 positioned at a position Ps43 and having a predetermined feature amount. The detection unit 44 compares the capturing target Tg4 in the detection limitation range Ar22 with the capturing target Tg3 in the previous tracking limitation range Ar23 based on the extraction result. As a result of the comparison, the detection unit 44 determines that a feature point exceeding the feature amount of the capturing target Tg3 in the previous tracking limitation range Ar23 is extracted, and changes the capturing target from the current capturing target Tg3 to the next capturing target Tg4. The detection unit 44 changes the detection limitation range Ar22 to the tracking limitation range Ar22, and changes the next detection limitation range to another adjacent detection limitation range Ar23.

The image processing device 4 in the frame F10 may predict the position of the capturing target Tg4 in the frame F11 by the prediction unit 43, and set the limitation range Ar23 including a position Ps45 as the predicted position as the tracking limitation range Ar23. In such a case, the detection limitation range Ar23 changed in the frame F10 may be further changed to another detection limitation range Ar11.

In a frame F10, the camera switching unit 47 maintains the connection destination of the switch SW as the camera 3b including the same tracking limitation range Ar22 as in the frame F9 in the capturing range. The detection unit 44 reads the tracking limitation range Ar22 at high speed. The detection unit 44 detects the capturing target Tg4 positioned at the position Ps44. The measurement unit 45 measures the movement amount of the capturing target Tg4 based on the position Ps43 of the capturing target Tg4 in the frame F9 and the position Ps44 of the capturing target Tg4 in the frame F10 based on the detection result. The output unit 46 calculates the movement speed of the capturing target Tg4 based on the measured movement amount of the capturing target Tg4, outputs the speed difference between the movement speed of the capturing target Tg4 and the flight speed of the drone 2A, and transmits the difference to the error correction unit 23 via the communication unit 25.

Since the capturing target Tg4 is positioned on a boundary line of the limitation range Ar22 in the frame F10, the image processing device 4 may execute the processing in step St52 in the flowchart shown in FIG. 13 to correct the range of the limitation range Ar22 or the limitation range Ar23.

In a frame F11, the camera switching unit 47 maintains the connection destination of the switch SW as the camera 3b including the detection limitation range Ar23 in the capturing range. The detection unit 44 reads the detection limitation range Ar23 at high speed. The detection unit 44 extracts the capturing target Tg4 as a feature point positioned at a position Ps45 and having a predetermined feature amount. The detection unit 44 determines that the capturing target Tg4 is the capturing target Tg4 based on the extraction result, determines that the feature point is not extracted from the detection limitation range Ar23, and recursively changes the detection limitation range Ar23 to the detection limitation range Ar11.

The image processing device 4 in the frame F11 may determine that the extracted capturing target Tg4 is the capturing target Tg4, and may calculate the movement amount and the movement speed of the capturing target Tg4 based on the position Ps44 of the capturing target Tg4 in the frame F10 and the position Ps45 of the capturing target Tg4 in the frame F11.

In the above description with reference to FIGS. 14 and 15, the detection limitation range is sequentially changed from the limitation range Ar11 to the limitation range Ar23, whereas the detection limitation range may be changed (set) at random. The example in which the prediction unit 43 in the description of FIGS. 14 and 15 predicts the position of the capturing target at the timing at which each of the plurality of cameras 3a and 3b is switched is described, whereas the timing for prediction is not limited thereto. For example, the prediction unit 43 may predict the position of the capturing target before changing the tracking detection range and the detection limitation range in the next frame.

As described above, the image processing device 4 according to other modifications can change the tracking limitation range and the detection limitation range reflecting the predicted position, and thus can track the capturing target more efficiently and detect another capturing target. The image processing device 4 according to other modifications can obtain a larger number of samplings (in other words, the number of pieces of error information to be output) in the same time, and thus the accuracy of position error correction can be made higher.

As described above, the image processing device 4 according to the first embodiment includes the reception unit 42 that receives the position information of the capturing target Tg1 and the captured image of the capturing target Tg1 captured by at least one camera 3, the prediction unit 43 that predicts the position of the capturing target Tg1 in the capturing range IA1 of the camera 3 based on the position information of the capturing target Tg1, the detection unit 44 that reads the captured image of the limitation range Ar1, which is a part of the capturing range IA1, from the captured image of the capturing range IA1 based on the predicted position of the capturing target Tg1, and detects the capturing target Tg1, the measurement unit 45 that measures the detected position of the capturing target Tg1, and the output unit 46 that outputs the difference between the measured position of the capturing target Tg1 and the predicted position.

Accordingly, the image processing device 4 can execute efficient image processing on the image of the capturing target Tg1 captured by the camera 3 and calculate the position error of the capturing target Tg1 with higher accuracy. Further, since the image processing device 4 according to the first embodiment can shorten the reading time by limitedly reading the limitation range of the capturing range IA1, it is possible to prevent the influence on the operation speed of other devices. Accordingly, the image processing device 4 according to the first embodiment can increase the number of samplings by shortening the reading time, and thus can implement more accurate position error correction.

The image processing device 4 according to the second embodiment and other modifications includes the reception unit 42 that receives the position information of each of the plurality of cameras 3a and 3b and the captured image captured by at least one camera, the detection unit 44 that reads the captured image in the limitation range that is a part of the capturing range of the camera from at least one captured image and detects the feature point (capturing target Tg3) that is the reference of the position of the camera, the measurement unit 45 that measures the detected position of the capturing target, the prediction unit 43 that predicts, based on the measured position of the capturing target, the position of the capturing target appearing in the captured image captured after the captured image used for the detection of the capturing target, and the output unit 46 that outputs the difference between the predicted position of the capturing target and the measured position of the capturing target.

Accordingly, the image processing device 4 according to the second embodiment and other modifications can execute efficient image processing on the image of the capturing target Tg3 captured by the camera, and calculate the position error of the capturing target with higher accuracy. Further, since the image processing device 4 according to the second embodiment and other modifications can shorten the reading time by limitedly reading the limitation range of the capturing range of the camera, it is possible to prevent the influence on the operation speed of other devices. Accordingly, the image processing device 4 according to the second embodiment and other modifications can increase the number of samplings by shortening the reading time, and thus can implement more accurate position error correction. Therefore, when the image processing device 4 according to the second embodiment and other modifications is used, the drone 2A can execute posture control during flight based on the output positional difference.

The image processing device 4 according to the second embodiment and other modifications further includes the camera switching unit 47 that switches connection with each of the plurality of cameras having different capturing ranges. The camera switching unit 47 performs switching to a camera capable of capturing a predicted position among the plurality of cameras according to the predicted position. Accordingly, the image processing device 4 according to the first embodiment, the second embodiment, and other modifications can switch each of the plurality of cameras 3a and 3b according to the position of the capturing target Tg3 predicted by the prediction unit 43. Therefore, it is possible to shorten the time associated with the movement of each of the plurality of cameras 3a and 3b, and it is possible to execute efficient image processing on the captured image of the capturing target Tg3. Therefore, when the image processing device 4 according to the second embodiment and other modifications is used, the drone 2A can receive a larger number of positional differences in a certain period of time, and can execute the posture control with higher accuracy based on each of the positional differences.

The camera switching unit 47 in the image processing device 4 according to the second embodiment and other modifications sets a camera that includes the predicted position of the capturing target Tg3, reads the limitation range, and tracks the capturing target Tg3 as a tracking camera, sets another camera that reads the limitation range other than the capturing range of the tracking camera, and detects another capturing target Tg4 as a detection camera, and performs switching between the tracking camera and the detection camera. Accordingly, the image processing device 4 according to the second embodiment and other modifications can efficiently execute tracking of the capturing target Tg3 and detection of another capturing target Tg4 and execute efficient image processing by switching the camera by the camera switching unit 47. The image processing device 4 can correct the position error while maintaining the accuracy while preventing a decrease in the number of samplings of the capturing target Tg3 by simultaneously executing the tracking of the capturing target Tg3 and the detection of another capturing target Tg4. Therefore, when the image processing device 4 according to the second embodiment and other modifications is used, the drone 2A can always receive the positional difference, and can execute the posture control more stably.

The camera switching unit 47 in the image processing device 4 according to the second embodiment and other modifications sets a limitation range including the predicted position of the capturing target Tg3 among a plurality of limitation ranges included in each of the plurality of cameras as a tracking limitation range, sets at least one limitation range among other limitation ranges other than the tracking limitation range as a detection limitation range for detecting another capturing target Tg4, and performs switching between the tracking limitation range and the detection limitation range. Accordingly, the image processing device 4 according to the second embodiment and other modifications can more efficiently execute the switching of the camera by the camera switching unit 47 by setting the tracking limitation range for tracking the capturing target Tg3 and the detection limitation range for detecting another capturing target. Therefore, the image processing device 4 can efficiently execute the reading processing of the captured image. The image processing device 4 can correct the position error while maintaining the accuracy while preventing a decrease in the number of samplings of the capturing target Tg3 by simultaneously executing the tracking of the capturing target Tg3 and the detection of another capturing target Tg4. Therefore, when the image processing device 4 according to the second embodiment and other modifications is used, the drone 2A can always receive the positional difference, and can execute the posture control more stably.

The detection unit 44 in the image processing device 4 according to the second embodiment and other modifications detects at least one feature point that is included in each of the limitation ranges of at least two captured images and has a predetermined feature amount. Accordingly, the image processing device 4 according to the second embodiment and other modifications can detect at least one feature point having the predetermined feature amount from the captured image. Therefore, even when there is no capturing target, a mark with high reliability can be set. Therefore, the image processing device 4 can execute efficient image processing on the image of the capturing target captured by the camera and calculate the position error of the capturing target with higher accuracy. Therefore, when the image processing device 4 according to the second embodiment and other modifications is used, the drone 2A can receive the positional difference with higher reliability and execute the posture control based on the difference.

The detection unit 44 in the image processing device 4 according to the second embodiment and other modifications corrects the limitation range based on the distribution of each of the plurality of detected feature points. Accordingly, when the set limitation range is not appropriate (for example, a feature point having a larger number of feature amounts is positioned on an end side rather than a center portion of the limitation range), the image processing device 4 according to the second embodiment and other modifications can correct the limitation range based on the distribution of each of the plurality of feature points detected from the read captured image. Therefore, the image processing device 4 can correct the read range and detect more reliable feature points. Therefore, when the image processing device 4 according to the second embodiment and other modifications is used, the drone 2A can receive the positional difference with higher reliability and execute the posture control based on the difference.

The detection unit 44 in the image processing device 4 according to the second embodiment and other modifications sets the detected feature points as other capturing targets. Accordingly, the image processing device 4 according to the second embodiment and other modifications can set more reliable feature points as the capturing targets. Therefore, the image processing device 4 can calculate the position error of the capturing target with higher accuracy. Therefore, when the image processing device 4 according to the second embodiment and other modifications is used, the drone 2A can receive the positional difference with higher reliability and execute the posture control based on the difference.

The measurement unit 45 in the image processing device 4 according to the second embodiment and other modifications measures the movement amount of the capturing target based on each position of the detected capturing target Tg2, and the output unit 46 calculates and outputs the movement speed of the capturing target Tg2 based on the measured movement amount of the capturing target Tg2. Accordingly, the image processing device 4 according to the second embodiment and other modifications can calculate the movement speed of the capturing target Tg3. Therefore, the image processing device 4 can predict the position of the capturing target Tg3 with higher accuracy. In addition, the image processing device 4 can more efficiently control the operation of the camera switching unit 47 based on the predicted position, and can efficiently set the next capturing target before the capturing target is lost. Therefore, when the image processing device 4 according to the second embodiment and other modifications is used, the drone 2A can always receive the positional difference, and can execute the posture control more stably.

The reception unit 42 in the image processing device 4 according to the second embodiment and other modifications further receives the moving speed information of the camera, and the output unit 46 calculates and outputs the difference between the calculated movement speed of the capturing target and the moving speed information of the camera. Accordingly, the image processing device 4 according to the second embodiment and other modifications can correct not only the error in the position of the capturing target but also the control error of the actuator 2 that moves the camera. The actuator 2 can correct the position error of the camera based on the output the speed difference. Therefore, the image processing device 4 can calculate the position error of the capturing target with higher accuracy, and can calculate the control error of another device (for example, the actuator 2). Therefore, when the image processing device 4 according to the second embodiment and other modifications is used, the drone 2A can always receive the positional difference and the speed difference, can execute the posture control more stably, and can correct the flight control error of the drone 2A.

Although various embodiments have been described above with reference to the accompanying drawings, the present disclosure is not limited to such embodiment. It will be apparent to those skilled in the art that various changes, modifications, substitutions, additions, deletions, and equivalents can be conceived within the scope of the claims, and it should be understood that these changes, modifications, substitutions, additions, deletions, and equivalents also belong to the technical scope of the present disclosure. Components in the various embodiments mentioned above may be combined optionally in the range without deviating from the spirit of the invention.

The present application is based on a Japanese Patent Application (Japanese Patent Application No. 2019-127912) filed on Jul. 9, 2019, the contents of which are incorporated by reference in the present application.

### INDUSTRIAL APPLICABILITY

In the presentation of the image processing device and the image processing method, the present disclosure is useful as presentation of the image processing device and the image processing method that execute efficient image processing on an image of an object captured by a camera and calculate a position error of the object with higher accuracy.

### REFERENCE SIGNS LIST

1: control device
10, 20, 40: control unit
11, 21, 41: memory
12: area data
2: actuator
22: drive unit
23: error correction unit
24: arm unit
3: camera
4: image processing device
42: reception unit
43: prediction unit
44: detection unit
45: measurement unit
46: output unit
5: working unit
IA1: capturing range
Pt0: reference marker
Tg1: capturing target

1. An image processing device comprising:
a processor; and
a memory storing instructions, when executed by the processor, causing a computer to perform operations comprising:
receiving position information of a capturing target and a captured image of the capturing target captured by at least one camera;
predicting a position of the capturing target within a capturing range of the camera based on the position information of the capturing target;
detecting the capturing target by reading a captured image of a limitation range that is a part of the capturing range from the captured image of the capturing range based on a predicted position of the capturing target;
measuring a position of a detected capturing target; and
outputting a difference between a measured position of the capturing target and the predicted position.

2. An image processing device comprising:
a processor; and
a memory storing instructions, when executed by the processor, causing a computer to perform operations comprising:
receiving position information of at least one camera and a captured image captured by the at least one camera;
reading a captured image in a limitation range, which is a part of a capturing range of the camera, from at least one captured image and detecting a capturing target serving as a reference of a position of the camera;
measuring a position of a detected capturing target; and
predicting, based on a measured position of the capturing target, a position of the capturing target appearing in a captured image captured after the captured image used for detection of the capturing target was captured; and
outputting a difference between a predicted position of the capturing target and the measured position of the capturing target.

3. The image processing device according to claim 1,
wherein the operations further comprise:
switching connection with each of a plurality of cameras having different capturing ranges,
wherein the switching the connection comprises performing switching to a camera capable of capturing an image of the predicted position in accordance with the predicted position.

4. The image processing device according to claim 3,
wherein the switching the connection comprises:
setting, as a tracking camera, the camera including the predicted position of the capturing target and that reads the limitation range and tracks the capturing target;
setting, as a detection camera, another camera that reads a limitation range other than the capturing range of the tracking camera and detects another capturing target; and
performing switching between the tracking camera and the detection camera.

5. The image processing device according to claim 3,
wherein the switching the connection comprises:
setting, as a tracking limitation range, the limitation range including the predicted position of the capturing target among a plurality of limitation ranges included in each of the plurality of cameras;
setting, as a detection limitation range for detecting another capturing target, at least one limitation range among other limitation ranges other than the tracking limitation range; and
setting switching between the tracking limitation range and the detection limitation range.

6. The image processing device according to claim 1,
wherein the operations further comprise:
detecting at least one feature point included in each of limitation ranges of at least two captured images and having a predetermined feature amount.

7. The image processing device according to claim 6,
wherein the operations further comprise:
correcting the limitation range based on a distribution of each of a plurality of detected feature points.

8. The image processing device according to claim 7,
wherein the operations further comprise:
setting the detected feature point as another capturing target.

9. The image processing device according to claim 8,
wherein the operations further comprise:
measuring a movement amount of the capturing target based on each of positions of the detected capturing target; and
calculating and outputting a movement speed of the capturing target based on a measured movement amount of the capturing target.

10. The image processing device according to claim 9,
wherein the operations further comprise:
receiving moving speed information of the camera; and
calculating and outputting a difference between a calculated movement speed of the capturing target and the moving speed information of the camera.

11. An image processing method to be executed by an image processing device connected to at least one camera, the image processing method comprising:
receiving position information of a capturing target and a captured image including the capturing target captured by the camera;
predicting a position of the capturing target within a capturing range of the camera based on the position information of the capturing target;
detecting the capturing target by reading a predetermined limitation range including the predicted position in the capturing range of the camera based on a predicted position of the capturing target;
measuring a position of the detected capturing target; and
outputting a difference between a measured position of the capturing target and the predicted position.

12. An image processing method to be executed by an image processing device connected to at least one camera, the image processing method comprising:
receiving a captured image captured by the camera;
reading a captured image in a limitation range, which is a part of a capturing range of the camera, from at least one captured image and detecting a capturing target serving as a reference of a position of the camera;
measuring a position of a detected capturing target;
predicting, based on a measured position of the capturing target, a position of the capturing target appearing in a captured image captured after the captured image used for detection of the capturing target was captured; and
outputting a difference between a predicted position of the capturing target and the measured position of the capturing target.

13. The image processing device according to claim 2,
wherein the operations further comprise:
switching connection with each of a plurality of cameras having different capturing ranges,
wherein the switching the connection comprises performing switching to a camera capable of capturing an image of the predicted position in accordance with the predicted position.

14. The image processing device according to claim 13,
wherein the switching the connection comprises:
setting, as a tracking camera, the camera including the predicted position of the capturing target and that reads the limitation range and tracks the capturing target;
setting, as a detection camera, another camera that reads a limitation range other than the capturing range of the tracking camera and detects another capturing target; and
performing switching between the tracking camera and the detection camera.

15. The image processing device according to claim 13,
wherein the switching the connection comprises:
setting, as a tracking limitation range, the limitation range including the predicted position of the capturing target among a plurality of limitation ranges included in each of the plurality of cameras;
setting, as a detection limitation range for detecting another capturing target, at least one limitation range among other limitation ranges other than the tracking limitation range; and
performing switching between the tracking limitation range and the detection limitation range.

16. The image processing device according to claim 2,
wherein the operations further comprise:
detecting at least one feature point included in each of limitation ranges of at least two captured images and having a predetermined feature amount.

17. The image processing device according to claim 16,
wherein the operations further comprise:
correcting the limitation range based on a distribution of each of a plurality of detected feature points.

18. The image processing device according to claim 17,
wherein the operations further comprise:
setting the detected feature point as another capturing target.

19. The image processing device according to claim 18,
wherein the operations further comprise:
measuring a movement amount of the capturing target based on each of positions of the detected capturing target; and
calculating and outputting a movement speed of the capturing target based on a measured movement amount of the capturing target.

20. The image processing device according to claim 19,
wherein the operations further comprise:
receiving moving speed information of the camera; and
calculating and outputting a difference between a calculated movement speed of the capturing target and the moving speed information of the camera.
